(19) United States
(12) Patent Application Publication
(10) Pub. No.: US 2007/0006406 A1
(43) Pub. Date: Jan. 11, 2007

(54) Small form factor cascade scrubber

(75) Inventors: John McEntee, Boulder Creek, CA (US); David T. Frost, San Jose, CA (US); Bryan Reginald Riley, San Jose, CA (US)

Correspondence Address: JACQUES M. DULIN, ESQ. DBA;INNOVATION LAW GROUP, LTD., 237 NORTH SEQUIM AVENUE, SEQUIM, WA, 98382-3456, US

(73) Assignee: Xyratex Technologies Ltd., Havant Hampshire (GB)

(21) Appl. No.: 11/456,201

(22) Filed: Jul. 8, 2006

Related U.S. Application Data
(60) Provisional application No. 60/697,600, filed on Jul. 8, 2005.

(51) Int. Cl. B08B 1/02

(52) U.S. Cl. 15/77; 15/88.3

(57) ABSTRACT

Small form factor pallet assembly, comprising a slotted plate having at opposite ends a mandrel drive assembly and an idler assembly, each with end fittings for engaging the drive and manifold block of a cascade-type scrubber permits scrubbing of SFF substrates by replacement of LFF scrub brushes with the SFF pallet. The SFF pallet slot is oriented below its brush nip so SSF substrates can engage the LFF rotation belt and transport drive. The drive chain is fitted with multi-finger yokes of different sizes so that several sizes of SFF substrates can be scrubbed in the pallet with a single chain. Trolleys for lateral transport of substrates from the input zone to the scrubber lane and from it to the output bay are disclosed. The inventive SFF pallet system meets the changing needs of the hard drive industry, and its retrofit capacity extends the life of already-installed LFF cascade scrubbers.

### CROSS REFERENCE TO RELATED APPLICATIONS

This application is the Regular application of Provisional U.S. Application Ser. No. 60/697,600 filed Jul. 8, 2005 by the same inventors under the same title, the benefit of the filing date of which is hereby claimed under one or more of 35 US Code §§ 119(e), 120, 121, 365(c) as applicable.

### FIELD

The invention is directed to substrate preparation systems and methods, and more particularly to apparatus and methods for cleaning of disk-shaped substrates, including silicon wafers of the type used in the fabrication of computer chips, and aluminum, ceramic, plastic, glass and multi-component disks for data storage devices such as hard disk drives (HDD), compact discs (CD), digital video discs (DVD), and the like, used in the computer, information and entertainment industries. A major aspect of the invention is provision of a pallet assembly comprising a framework in which small scrubber mandrels with brush elements are mounted, which is retro-fit-able into the footprint, and interfaces with cleaning fluid and drive systems of currently commercially available 95 and 65 mm disk cascade scrubbers so that the mandrels can clean small disks of size less than 50 mm diameter.

### BACKGROUND

The computer, information, and entertainment industries produce and consume annually in excess of a billion disk-shaped substrates, principally silicon wafers, and aluminum, plastic, glass, or other multi-component disks. In the fabrication of computer CPU chips, silicon wafers are processed through multiple fabrication steps which include repeated application and selective removal of variously conductive, non-conductive and semi-conductive materials before the resulting micro-circuits are complete and separated into individual dies.

With respect to memory media of the hard drive type that utilize disk substrates, aluminum, glass, and other composite disk substrates are in current use. The substrates are over-coated with one or more layers of magnetic, optical, or magneto-optical materials in the fabrication of HDDs, CDs, DVDs, and other data storage products. As technology related to areal density improves, ever smaller disks are able to hold as much or more information than their larger counterparts. For example, 1″ (25 mm) and smaller disks are being used in cell phones and portable music players.

Substrates must be buffed, polished, etched, textured, cleaned, and otherwise prepared repeatedly during the fabrication process, both before sputtering with magnetic media and afterwards. By way of example, a microscopic contaminant of size on the order of 0.1 micron left on the surface of a hard drive disk substrate could cause the hard drive to fail, as the clearance between the drive head and the substrate magnetic media is only on the order of 0.0125 microns (0.5 micro-inches). Accordingly, the standard of cleanliness of hard drive substrates currently required in industry permits no more than 1 particle per side of size no greater than 0.1 micron.

To meet the ever increasing demands for cleaner substrates, both semiconductor and disk industries adopted rotating brush scrubbing as the standard cleaning procedure. In cascade-type scrubbers, each brush station includes one or more pair(s) of brushes. The brush material is usually polyvinyl alcohol (PVA), but other materials such as mohair and nylon can be used. To keep the brushes clean and extend the brush life, it is common practice to deliver water or other cleaning fluid from the exterior or/and the interior, that is, through a hollow brush core. The brush core has a one open end for cleaning fluid input.

In hollow core type mandrels, the cleaning fluid is delivered from the interior of the brush core to the interface of the brush and substrate surface being cleaned through a series of fine holes or channels distributed along the longitudinal length of the brush and passing through the wall of the brush. The open end of the brush core is coupled with a supply housing that provides cleaning fluid under pressure that continuously passes through the holes and flushes the interface of the brush with the substrate surface being cleaned.

Presently, commercially available cascade scrubber systems are available from Xyrates Technologies, Inc of Scotts Valley, Calif. (formerly Oliver Design, Inc.). These cascade scrubbers are designed for 65 mm (about 2½″), 95 mm (about 3¾″) and 48 mm (about 2″) diameter substrate, principally aluminum, disks. However, the industry is moving toward smaller glass disks, on the order of 21.6-40 mm (about ⅞″ to about 1.5″) diameter, for use in cell phones and other micro-devices such as portable storage media, music players, and the like. Even smaller, ¾ to ½″ diameter disks are anticipated (that is, as small as 10 mm) as ubiquitous data storage device components.

Accordingly, there is a need in the art for a cascade scrubber cleaning system that can handle smaller disks, and more particularly a system that includes a method for cleaning various new disk sizes simultaneously, that can be retrofit in the existing equipment base, and is simple and inexpensive to manufacture and maintain.

### THE INVENTION

### Summary of the Invention, Including Objects and Advantages

The present invention provides a simple and economic solution to resolve the issue of cleaning a plurality of sizes of small substrate disks by providing a Small Form Factor (herein “SFF”) pallet assembly comprising a framework in which small scrubber mandrels with brush elements are mounted, which is retrofittable into the footprint, and interfaces with cleaning fluid and drive systems of currently commercially available 95/65/48 mm disk cascade scrubbers so that the mandrels can clean small substrate disks, defined as substrate disks of size less than 45 mm diameter. The system includes a robotic handler for loading and unloading disks from incoming and to outgoing cassettes each carrying groups of 50 disks or more. The robotic handler assembly system is disposed, relative to the SFF scrubber bay, in an H-configuration, as seen in plan view, that is, at each end of the SFF scrubber bay. The handler includes pick up arms that unload/load incoming and outgoing cassettes onto disk nests, pick from/to the nests, traverse (shuttle laterally) between incoming and outgoing disk cassettes/nest station and the nip of the scrubber mandrels at each end thereof, and whose motion is timed to coordinate with the intermittent indexing motion of the SFF longitudinal disk transport system to advance disks along and through the scrubber stations of the inventive SFF pallet.

For the background context of cascade scrubber modules for hard-drive disk substrate cleaning into which the inventive pallet assembly is retrofit, refer to U.S. Pat. No. 6,625,835 and Published Regular US Application 2005-0015903, published Jan. 27, 2005 (Ser. No. 10/625,973 filed Jul. 23, 2003 by Adam Sean Harbison et al, entitled SEAL SYSTEM FOR IRRIGATED SCRUBBER MANDREL ASSEMBLY), the subject matter of which are hereby incorporated by reference as if reproduced here to the extent necessary for technical support.

The inventive SFF cascade scrubber system includes a longitudinal disk transport assembly comprising chain driven, spaced, adjustable finger yokes running parallel to a grooved disk-rotation drive track to replace the full-sized finger yoke system in the Disk Cascade Scrubber, U.S. Pat. No. 6,625,835. The inventive SFF system also includes a small-brush pallet assembly that replaces the full-sized, double-mandrel, internally irrigated, brush mechanism of that patent with a smaller, externally irrigated, double brush system. The inventive SFF pallet comprises a framework and paired small mandrels that couple with, engage and replace the drive system of the larger, currently available mandrels (disclosed for example in the above identified Published Application 2005-0015903 which has been incorporated by reference herein.

In combination, the inventive small form factor adjustable finger yoke and disk rotation transport system and cylindrical brush pallet transform the large format Disk Cascade Scrubber to an SFF scrubber, enabling it to clean small disks, yet the assemblies are removable to allow the flexibility of reattaching the larger disk form-factor scrubber mandrels, where the disk manufacturer has runs of the full range of disk form factors. That is, the inventive SFF system pallet substantially extends the range of use of the currently-available Cascade Scrubber modules to the full menu of disk substrate sizes, and does so in the same factory floor footprint. By the retrofit and interface properties of the inventive SFF cascade scrubber pallet system, the life of the larger machines is extended as the industry develops ever-smaller data storage disks.

The small sized disk substrates pose unique cleaning and handling problems, in large part due to their size, fragility, composition and light weight, to name four principal problem-causing parameters. As a result, the handling must be delicate, yet positive; glass substrates are on the order of 0.16 mm or less thick, and can shatter. Their small size means the positioning of the scrubber nip and the motions of the pick-and-place robotic handler must be precise, and aligned (not skewed) over the relatively long transfer distances from the scrubber bay to the nests. Further, the substrate composition, being glass raises additional problems, in that wetted disks not only stick together by virtue of their cleanliness (like material self-bonding) but also due to hydration bonding. That is, the film of water will cause the disks to stick together. In addition, disks that “lean” during handling will be attracted-to, and stick-to, adjacent handling equipment by water droplets. Other forces that cause the disks to mis-align or indeed fly off the handling equipment include vibration and air currents. Once the disks fall off or fly off, they are essentially invisible, being transparent glass. And where they fall can cause problems, including jamming equipment and contaminating other disks, thereby reducing process yield. Being light weight, the disks pose in-scrubber transport problems, in that the forces to move the disk must overcome brush drag, water meniscus and attractive forces, yet not be abrupt, causing disks to jump. The light weight and smooth glass composition means that glass disks may have a tendency to slip instead of rotate during longitudinal movement through the scrubber zones. Finally, the spacing of the mandrels above the belt is important. That is the centerline of the mandrel needs to be at the center line of the disk to insure fill coverage of the disks. Too high or too low, will clean only an annulus of the disk. These are good examples of application-specific problems attendant upon change of scale and nature of materials (size, weight, composition, fragility), the solutions to which are not pointed to by larger scale systems.

As for the SFF pallet disk transport (drive) system components, the disks are moved longitudinally from the input end to the output end of the scrubber nip by a chain or belt drive that has pusher fingers terminating in rollers that contact the lower periphery of the disk. This drive assembly is located below the scrubber mandrels. In addition, the disk is rotated by a grooved belt running in a track centered below the nip of the scrubber mandrels. The substrate edge contacts the groove. Typically, the grooved belt is driven in a direction opposite the direction of the chain/pusher drive, but may optionally be driven in the same direction. Thus, as the disk substrates traverse, say from left to right through the cascade scrubber assembly, the counter-rotating grooved belt imparts a clockwise rotation to the substrates. The belt profile must be specially configured for the small disks, in that the belt groove must be small enough to accept the edge of the disks but not a substantial area of the sides, yet provide suitable gripping surface to effect disk rotation. Within the scope of this invention, the belt can include, additionally and optionally, spaced transverse grooves, flutes or treads (raised ribs) to provide positive, continuous disk rotation. The disk rotation belts are preferably made of polyurethane of durometer in the range of from 60 to about 100. Other belt materials that can be used include alternating block homo and co-polymers of polyolefins such as polyethylene or/and polyproplylene, fluorosil, fluoro-elastomere (FKM, FPM), acrylonitrile-butadiene (NBR), urethane co-polymers, styrene-butadiene (SBR), ethylene propylene (EPDM, EPM), and other polymers.

The belt is a long profile of fixed cross-section, joined in a loop by splicing, preferably extruded, but may be pultruded if fiber reinforced, molded, pressure-formed and radiation cross-linked, or manufactured by lay-up (a common way to make belts). Alternative materials include any elastomer that is compatible with the chemistry used in the cascade scrubber and that is sufficiently flexible to elastically deform around the pulley radii while stretched taut, without significant plastic deformation (dependent on specific cross-sectional profile, the pulley radius, and tension applied. In addition to a fiber reinforced elastomer, made by layup or pultrusion, a composite belt made of compatible, flexible materials including stainless steel bands, elastomer layers, and fiber or fiber-reinforced layers can be used. These layers may be bonded, vulcanized, co-molded, pultruded, interlocked, or otherwise joined to create a single profile.

In the inventive SFF cascade scrubber palette system, the disk transport indexes the disks intermittently between stations. In a first embodiment, there are three stations along the longitudinal plane of the nip between the brushes. The disk pick-and-place handler shuttles between a cassette receiving (input) station that is oriented orthogonally to the scrubbing plane. It puts a first disk into station one. The disk is cleaned there while being rotated by the grooved drive belt underneath and contacting the edge of the disk. The disk is cleaned for a time period ranging from about 5 to about 20 seconds, and then the SFF scrubber pallet disk transport moves the disk quickly and smoothly to station 2 which is located about 4-8″ along the mandrel nip (scrubbing) plane. The disk is cleaned there for a similar period and then incremented to station 3 where is cleaned and then picked up and stacked in the outgoing nest for placement in a transfer cassette for movement to the next processing module. The time period in the stations can all be the same or varied.

The inventive SFF system for transport of disks along the scrubber stations provides 2-digit adjustable yokes, typically of two sizes (conventional large disk scrubbers use single fingers). The chain drive can be fitted with yokes of all the same size, or alternating different sized yokes are spaced along the chain. This latter is the preferred set-up, as it permits simple conversion from cleaning 21.6 mm disks to cleaning 35 mm without change of chain or installing new yokes. All that needs be done is to synchronize the placement of the larger disk in the appropriate yoke, or the space between adjacent yokes. For example, a first finger yoke with spacing for 40-48 mm disk between digits is spaced from a second yoke far enough to accept a 35 mm disk, and this yoke has finger spaced to accept a 21.6 mm disk between its fingers. The yokes alternate in that spacing secured along the drive chain that runs below and parallel to the plane of the nip between the SFF brush-mounted mandrels. Thus, three different sized disks can be sequenced onto the track in the finger yokes and spaces between them, rotated by the grooved disk rotation belt below and in which the disks ride, without change of drive chain. In the alternative, finger yokes of any size, attached to the track's chain drive in any sequence may be configured to render the apparatus useful even as disk sizes continue to evolve in the computer chip industry.

Another important feature of the inventive SFF pallet system is that the yokes are adjustable in X, Y and Z dimensions: The X dimension is longitudinal, that is parallel to the grooved disk rotation belt which is co-axial with the brush nip and defines the scrubber lane plane, e.g., Ln-1, Ln-2, . . . Ln-N; The Y dimension is lateral, that is horizontally orthogonal to the grooved disk rotation belt; The Z dimension is vertical, raising the rollers up or down with respect to the horizontal plane of the grooved disk rotation belt and the horizontal centerline of the brushes. The adjustments are implemented, in a principal embodiment, by use of slots and adjustment screws, the Z adjustment in the yoke vertical flange that connects it to the disk transport chain, the Y adjustment at the “wrist” juncture of the yoke “hand” portion to the vertical flange, and the X adjustment at the juncture of the individual fingers to the hand portion of the yoke assembly.

Thus, the SFF system provides for essentially infinite adjustability for any sized disks. For example, keeping X and Y dimensions the same, raising Z means a smaller disk can be retained in the groove for transport stability, while reducing Z (lowering the rollers) means a larger disk can be retained. This adjustability feature also permits retaining the disks at user-selected distances down from the center hole of the disks. Smaller, thinner disks may need to be held higher along their edges than larger ones, or vice versa, as processing conditions may be varied and controlled, as non-limiting examples: rotation speed of brushes; indexing interval (dwell time in each zone and time of transit between zones); speed of the transport chain drive; rinse fluid composition and flow rate; disk rotation rate (grooved belt drive speed); and disk rotation direction (clockwise vs counterclockwise); to name a few.

In the presently preferred embodiment of the SFF pallet, the brushes are wet only from the exterior, by a spray system of the scrubber assembly module. As the disks are smaller, exterior wetting has proven adequate for good rinsing of the disks during scrubbing. In this “dry mandrel” configuration, the water supply to the mandrel end housing of the scrubber assembly is turned off.

However, where needed for extra flushing-off of particulates, the inventive SFF brush mandrels may include a hollow core having a water supply from the idler end. The mandrel idler sockets are disposed in an end housing assembly in which a sliding piston inside the housing is configured with a flange having one or more recesses so that the piston is out of contact with the rotating part of the bearing assembly of the brush mandrel. The piston has a specially configured flange with an outer face that only contacts the stationary outer race of the mandrel bearing. The water supply piston is also configured with a full bore, that is, without a reduced bore forming a nozzle, thereby minimizing the hydraulic pressure of the input cleaning fluid so as to minimize the pressure on the end of the mandrel. In addition, a tolerance-controlled leak through the bearing is provided by the configuration of the outer, stepped face of the piston flange. This leak provides a flushing of the area in which wear might be a source of particle generation. Further, this controlled leak is up-stream of the brush core apertures, originates adjacent the potential wear faces and exits external to the brush upstream of it. In combination, these features function to substantially eliminate both the source of particle generation from contact wear between brush core mandrel and cleaning/rinsing fluid supply housing, and the contribution of such wear particles into the interface between the brush and the substrate surface being cleaned. In the full-sized version, two parallel mandrels terminate in two holes provided in the end housing assembly.

The inventive brush pallet, however, is smaller than its full-sized counterpart, and comprises two parallel mandrels equipped with rotating brushes terminating at a first end with an idler housing having short cylindrical or disk-shaped couplings that fit into the mandrel sockets of the original large form factor cascade scrubber mandrel housing system. The opposite end of the SFF pallet terminates in a geared transmission assembly having two projecting bayonet sockets that engage the drive pins of the original large form factor mandrel drive system. This drive counter-rotates the mandrels on which the brushes are mounted. Like its larger counterpart, the inventive SFF brush pallet is located above the chain drive/yoke transport system and grooved belt disk rotation system, its brushes counter-rotating to both scrub the disks from both sides, and push them downward, thus keeping them in contact with the grooved rotation belt and the grooved rollers on the ends of the yoke fingers.

In a preferred embodiment, spools having transverse flanges spaced about 4-8 mm apart are mounted on the mandrels close to the ends. These provide clearance for the lifter fingers to dip into the nip between the brushes without contacting the brush bristles or nubs. Thus, the mandrels include, from one end to the other: Short brush segment, spool, 3 or more longer brush segments defining the scrubbing zones, a second spool, and a short brush segment. The short brush segments are on the order of 15-30 mm long.

The inventive SFF pallet system also includes a robotic handler system that laterally transfers the disks in pairs (or more than 2 at a time) from incoming cassette receiving nests to the input nips of the scrubber lines, and the reverse at the output end (the end of the scrubber lines), in a series of motions: descend and engage disks, lift the disks, move laterally to the cleaning plane (plane of the nip between the brushes), descend to insert the disk in the insert space provided by the spools, release disk, lift out of the way, move laterally back to initial, start position.

In the presently preferred embodiment, the robotic handler includes pairs of lifters on which are mounted disk nests at each end and spaced to one side of the scrubber lines. These lifter-actuated nests receive/unload disks incoming from delivery cassettes, and present/load disks into outgoing cassettes. Once the disks are loaded onto the incoming nests, a disk transfer trolley of the robotic Pick-N-Place lateral transfer assembly having pairs of spaced arms (in the case of a 2-line scrubber module), moves laterally into place over the disks, descends to provide a finger next to the aperture in the disk, indexes over so a groove in the finger is aligned with the plane of the disk, then lifts the disks off the nest, transfers (moves) laterally over to the scrubber line, lowers the disk into the nip onto the rotational drive belt, indexes down slightly to disengage the tip of the finger from the inner marginal edge of the disk center hole, indexes laterally so the finger clears the disk, raises, and translates back to start (over the nest. That configuration is for a 2-line scrubber module. For 3, 4 or more line modules, the trolley is configured with the corresponding number of arms properly aligned to fetch and place disks from the corresponding number of nests.

It is preferred to configure the trolley arms with anti-vibration features, including arms and fingers parallel to the plane of the disks, reinforcing gussets, arms reinforced with ribs, robust and/or wide pick hooks or fingers, and the like. In addition, to insure precise alignment of the arm pairs with respect to each other at both rest positions: A. Over the nests; and B. over the scrubber brush nips, at least one finger includes a longitudinal position, fine adjustment system that provides precise alignment of the fingers with respect to each other by turn of a screw.

The preferred disk pick-ups are hook units attached to the end of the PNP trolley assembly fingers. These hooks descend to a position adjacent a disk and at a level where the upper tip of the hook clears the disk center hole, then indexes over to center the groove of the hook with the plane of the disk, and then rises to engage the inner periphery of the disk hole to lift and transport the disk. Where a disk pick hook is used to lift and transport disks by engaging the disk center hole, an optional releasable damper assembly can be employed to stabilize the disk.

In a second disk transfer assembly arm embodiment, the disk engagement lifters grasp the disks at multiple points along the disk periphery with a pair of forceps-type grooved fingers which open and close, contacting and lifting the disk at a point or region including slightly below the horizontal center line of the disk. The groove in each finger is generally V-shaped, so that the very edges, rather than the sides of the disk are contacted. The groove extends downwardly to the end of the lifter finger in order to provide a drip path for water. At the output end of the scrubber a similar robotic handler removes the disks from the last scrubber station and returns them to an outgoing, cleaned disk next for transfer to an outgoing cassette or cradle.

The transfer of disks from the cassettes to the nests, nests to nests, and the reverse is as follows: The incoming cassette is positioned at the output end of the upstream module (e.g., rinse, megasonic, ultrasonic, immersion tank, fresh (new disks production clean) over a lifter having a nest. The lifter raises the nest lifting the disks out of the cassette into position between the spaced arms of an inter-module horizontal transfer unit positioned over the nest. The arms close, taking the disks. The nest retracts to below the cassette. The inter-module transfer unit brings the disks into the scrubber module space and positions itself over the scrubber module lifter/nest assembly, which rises, accepts the disks. The inter-module transfer unit's arms open, and the disks are now on the scrubber nests, which lower into position for the disks to be picked by the arms of the scrubber lateral transfer trolley/arm unit. At the scrubber output end the reverse steps occur.

### BRIEF DESCRIPTION OF THE DRAWINGS

The invention is described in more detail with reference to the drawings, in which:

FIG. 1 is an elevated isometric from the front right corner of an exemplary 2-lane scrubber module of the invention showing the general layout of the scrubber lanes in relation to the input station on the left rear and the output station on the right rear, and the pick and place trolley/arm yoke assemblies shown. The input trolley over the input nests and the output trolley positioned over the output end of the scrubber lines:

FIG. 2 is a close up isometric of the output end of the scrubber module of FIG. 1 looking from an installed inventive small form factor pallet assembly toward the output nests, the trolley being positioned over the nests;

FIG. 3A is an isometric of a large form cascade scrubber with the mandrel/brushes mounted in place between the idler housing at the left end and the drive transmission assembly at the right end;

FIG. 3B is an isometric of the inventive SFF brushes pallet assembly before installation into the standard cascade scrubber manifold housing sleeves at the left end and coupling with the drive transmission at the right end;

FIG. 4A is an isometric of the transport configuration of a conventional large form disk cascade scrubber, the scrub brushes and mandrels removed for clarity;

FIG. 4B is an isometric of the inventive small form factor transport configuration which comprises modifications to the conventional disk cascade scrubber, the idler sockets and drive assemblies being shown at opposed ends;

FIG. 5A is an isometric view showing insertion of the inventive small form factor pallet assembly into the mandrel housing sleeves of a conventional large factor disk cascade scrubber and interfacing with the transport drive assembly beneath the pallet;

FIG. 5B is an isometric of the entire inventive SFF assembly as retrofittingly loaded into a conventional large form disk cascade scrubber footprint and with the drives coupled at the right end, showing disks traveling through the nip of the brushes in cleaning Zones 1-3 pallet on the track that sits below the pallet;

FIG. 6 is an isometric exploded view of the parts of the inventive pallet assembly;

FIG. 7A is an isometric view of the idler end of the inventive pallet;

FIG. 7B is an isometric view of the drive transmission end of the inventive pallet, with inner drive housing removed to show the drive gears and drive belts;

FIGS. 8A-8D are isometric views of features of the disk longitudinal transport and disk rotation drives, with: FIG. 8A showing a dual lane cascade scrubber into which one of the inventive pallets has been mounted: FIG. 8B showing a close up of the transport yoke system and the grooved disk rotation drive belt, FIG. 8C is a section view through the transport and rotation drive assembly; and FIG. 8D is an isometric view of both the prior art LFF non-adjustable single finger, single roller pusher and the inventive SFF dual roller X/Y/Z adjustable, universal yoke;

FIGS. 9A-C, 10A-C and 11A-C are line drawings of three embodiments of disk rotation belts, in which FIGS. 9A-C show the details of the belt for 27 mm disks and smaller, FIGS. 10A-C show the belt for 35 mm and larger disks, and FIGS. 11A-C show the details of a belt having transverse grooves or treads, in each of these series the FIGS. 9A, 10A and 11A are isometrics of the belt; FIGS. 9B, 10B and 11B are full profiles (cross sections); FIGS. 9C and 10C are enlarged profiles; and FIG. 11C is a plan view of the belt of FIG. 11A;

FIG. 12 is an isometric line drawing from below of the disk pick arm support yoke assembly mounted on the vertical elevator and lateral disk transfer assemblies;

FIG. 13A is an isometric of a first, preferred embodiment of the yoke, arm and finger assembly of the disk lateral transfer assembly showing it in position over tandem nests;

FIG. 13B is an isometric view of a second embodiment of the pick arm and support yoke assembly terminating in forceps-type fingers for grasping a disk, one disk being shown in position over tandem nests;

FIGS. 14A-D are isometric and side elevations, respectively of the preferred embodiment of the pick finger, in which FIG. 14A is the finger unit; FIG. 14B is a side elevation showing a disk loaded on the finger as attached to the “hand” with the optional anti-vibration damper in the “UP” position; FIG. 14C is a side elevation as in FIG. 14B but with the damper in the “DOWN” position; and FIG. 14D is a rear isometric showing the inlet ports for the pneumatic bi-acting cylinder for actuating the damper; and

FIGS. 15A and 15B are isometric views of an alternate (second) embodiment of the disk pick-up finger assembly of the pick arm of FIG. 13B, in which FIG. 15A is a close-up of the forceps type disk pick-and-place fingers with the fingers open; and FIG. 15B is a close-up of the fingers closed holding a disk in the grooves.

### DETAILED DESCRIPTION, INCLUDING THE BEST MODES OF CARRYING OUT THE INVENTION

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention, including what is presently believed to be the best modes of carrying out the invention. Being in a continuously wet environment and including cleaning compounds in the wetting or scrubbing fluids, the materials of construction include plastic, elastomers, stainless steel, brass and aluminum, the choice of which is within the skill of those experienced in this art.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

All publications, patents and applications cited in this specification are herein incorporated by reference as if each individual publication, patent or application had been expressly stated to be incorporated by reference.

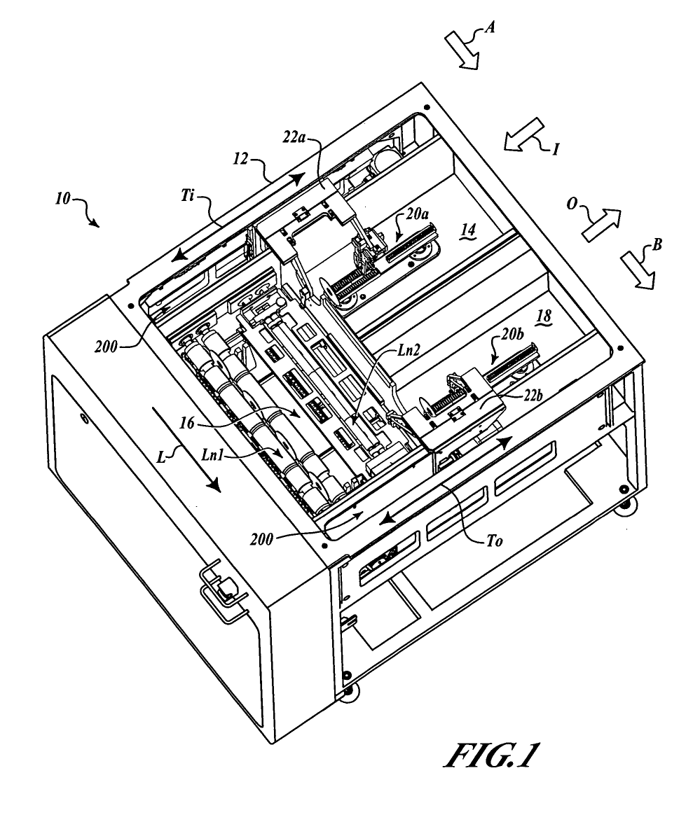

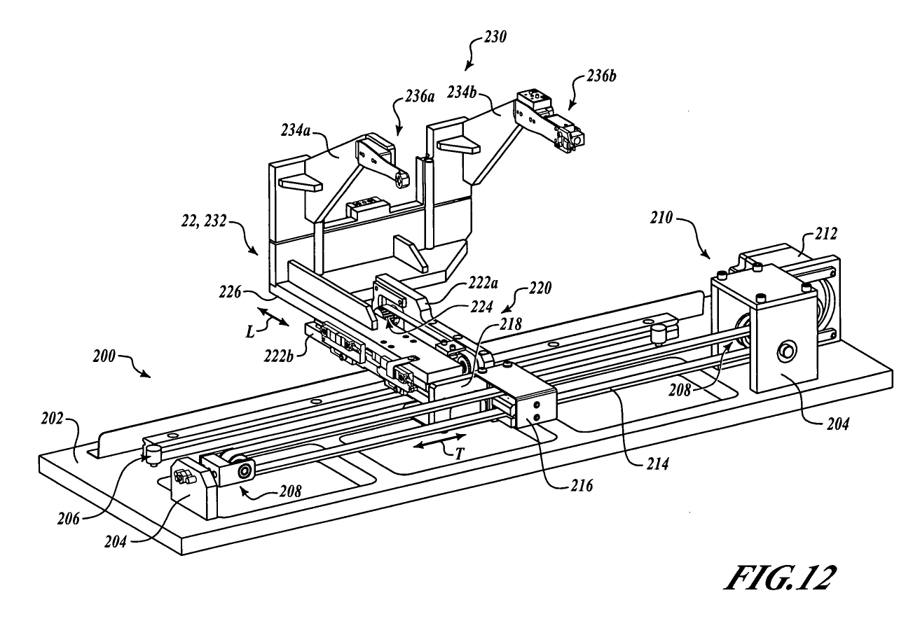

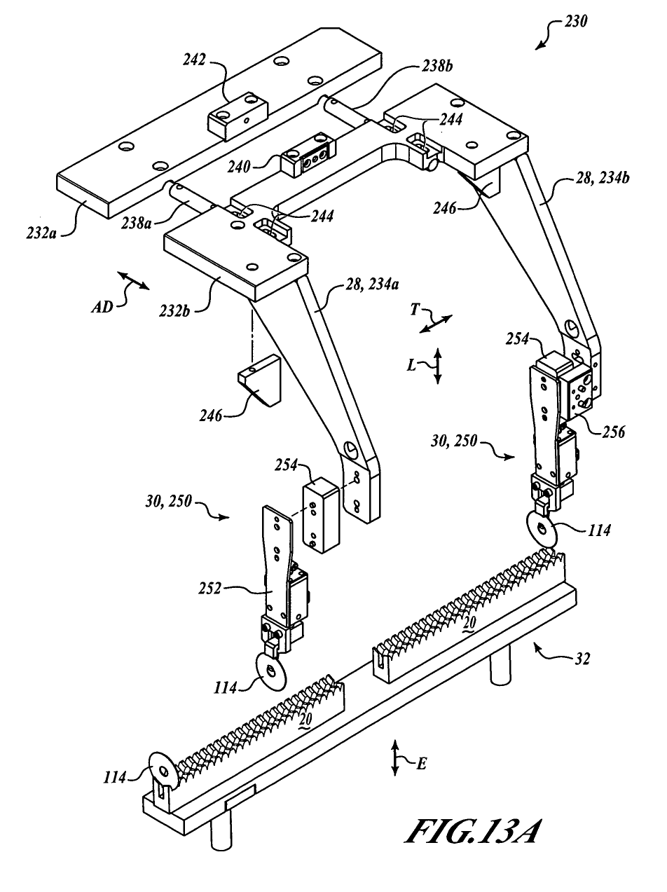

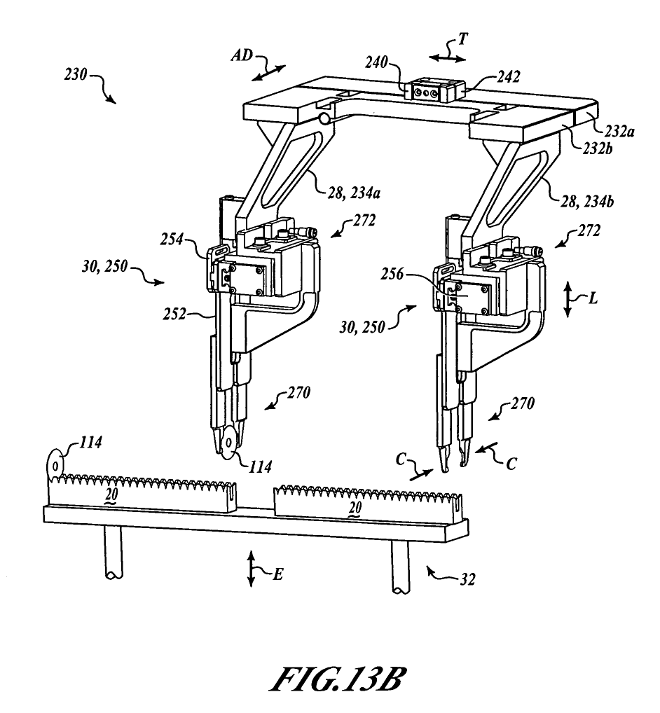

FIG. 1 shows disk cascade scrubber module 10 (the front being to the lower left), comprising a housing 12, from the top of which are accessible a plurality of bays, including a Disk Input Bay zone 14, a single or multi-line scrubber bay zone 16, and a Clean Disk Output Bay zone 16. Various control systems, water lines, drains, pumps and the like are disposed below the bays. So as to not obscure details of the scrubber and robotic handler assemblies (230, FIGS. 12, 13), the various water spray manifolds with spray tips are not shown in this view. This module is oriented in line with other modules both upstream and downstream for continuous cleaning processing of the disk substrates. Examples of upstream modules include: immersion rinse; megasonic tank; fresh DI water rinse. Examples of downstream modules include: megasonic tank, ultrasonic tank, hot DI water dryer, alcohol/DI water dryer. Arrow A identifies the flow of input cassettes carrying disks that need to be scrubbed from an upstream module. Arrow I shows the input of disks from a transfer cassette to the input disk nests 20a, and Arrow O shows the output of clean disks from the output nests 20b to an outgoing transfer cassette for further transfer to the next downstream module as shown by Arrow B. The cassettes (not shown) may be any standard disk transfer cassette appropriately sized for the substrate disks being processed. Alternatively, the disks can be transferred between modules by disk center-hole spindle carriers, such as shown in U.S. Pat. No. 6,446,355 (FIGS. 1A, 2A, 3E and 3F) or by edge forks.

As shown by Arrow Ti, the input lateral disk transfer trolley assembly 22a picks the disks from the input nest 22a, transports them laterally into the scrubber bay zone 16 and places them into the nip between the scrub brushes. During scrubbing the disks are transported longitudinally down the scrubber lanes, as indicated by the Arrow L. At the output end of the scrubber zone 16, the output lateral disk transfer trolley assembly 22b picks the disks out of the scrubber nip, and transfers them laterally to the output nest 20b, as shown by the Arrow To. As shown the layout of the input, scrubber and output zones is generally C-shaped as seen in plan view. Also, as shown in FIG. 1, two sizes of disks are being scrubbed: large form disks 96, such as 95 mm disks, in scrubber lane one, Ln1, and small form factor disks 24, such as 25 mm disks, in scrubber lane two, Ln2.

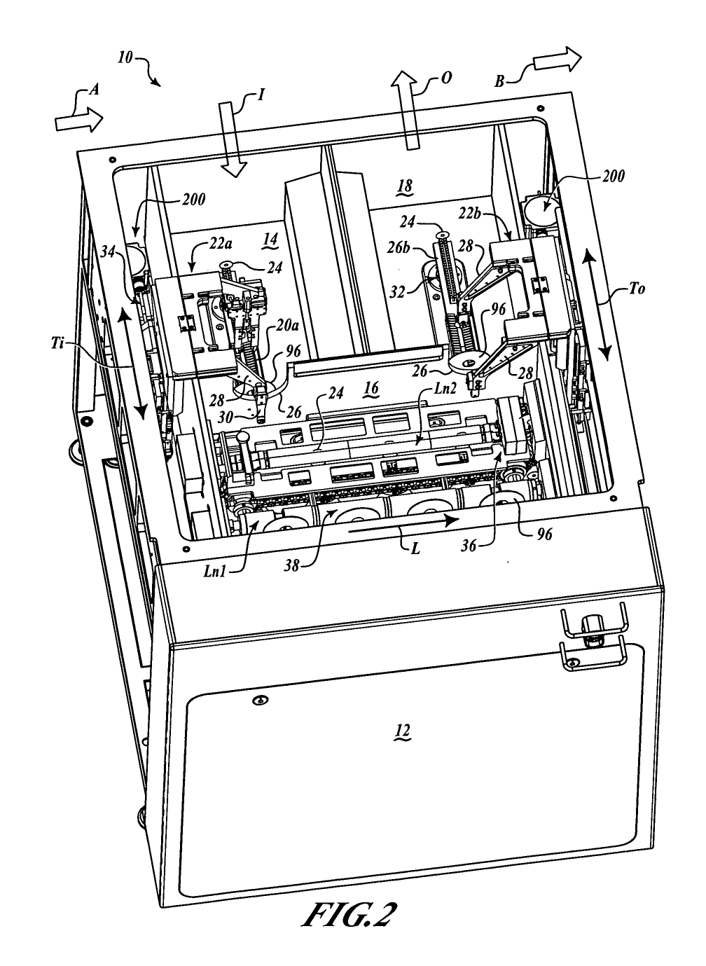

FIG. 2 also shows the module of FIG. 1, in this view more nearly from the front to better show the cut-out pass-throughs 26 between zones 14/16 and 16/18, respectively for the pick arms 28 and pick fingers 30 of the disk transfer trolley assemblies 22a, 22b to pass while carrying disks 24, 96. In addition, the SFF disks 24 are more clearly visible in Ln2, and the large disks 96 are more clearly visible in Ln1. The nest elevator mechanism 32 and the drive mechanism 34 of the disk transfer trolley assembly 22a is also seen in this view. Finally, the SFF pallet assembly 36 is shown in place fitted at the right end to the drive bayonet couplings and at the left end in the mandrel idler block of the regular (large) form factor scrubber. The regular, Large Form Factor (LFF) scrubber is shown at 38.

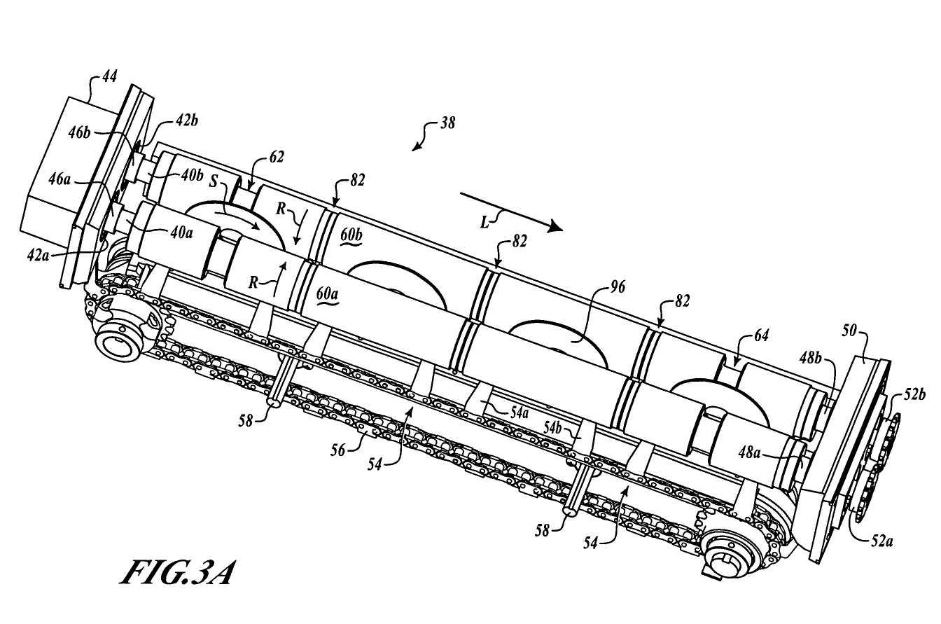

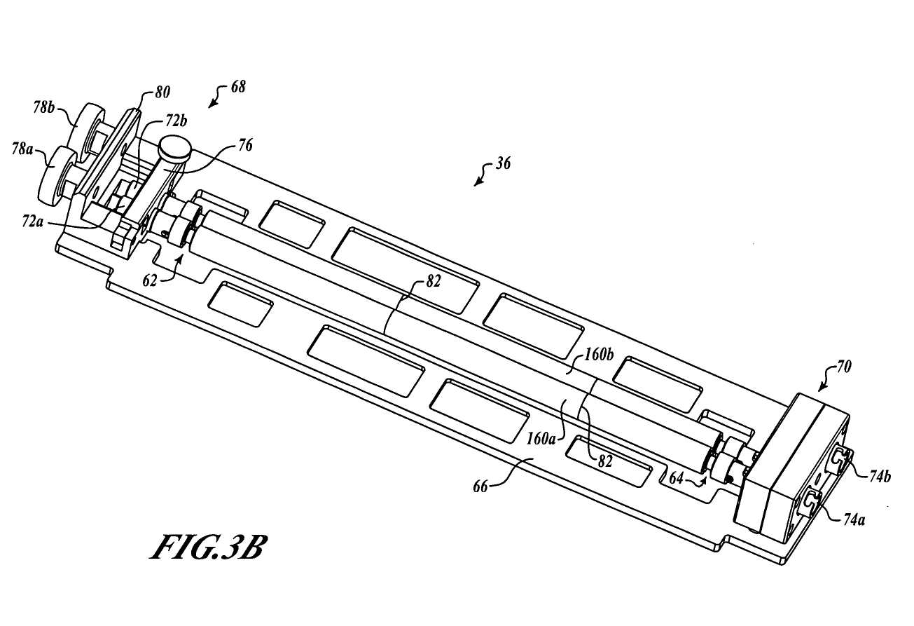

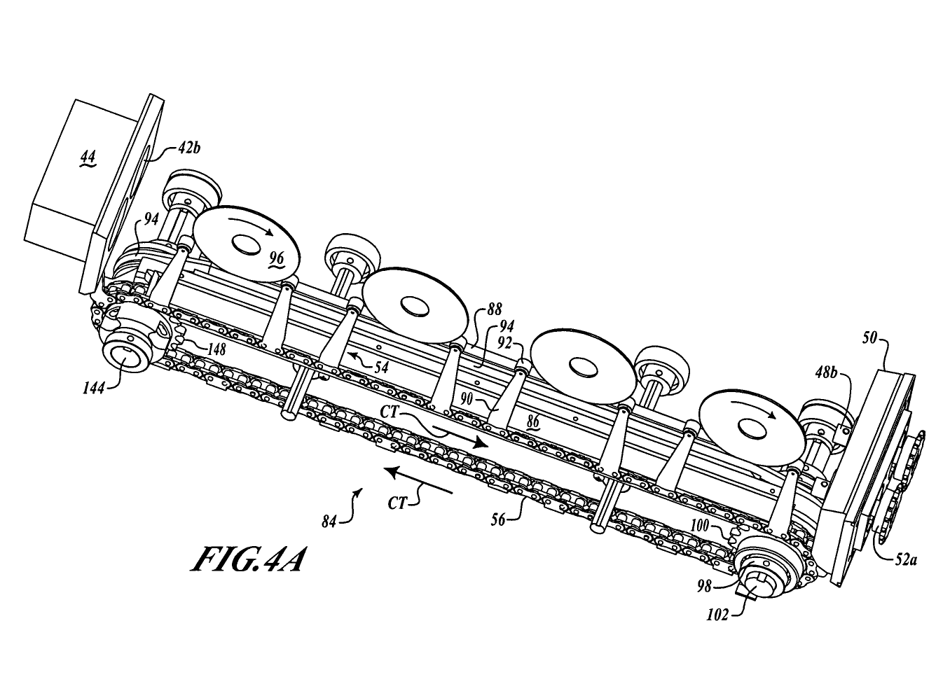

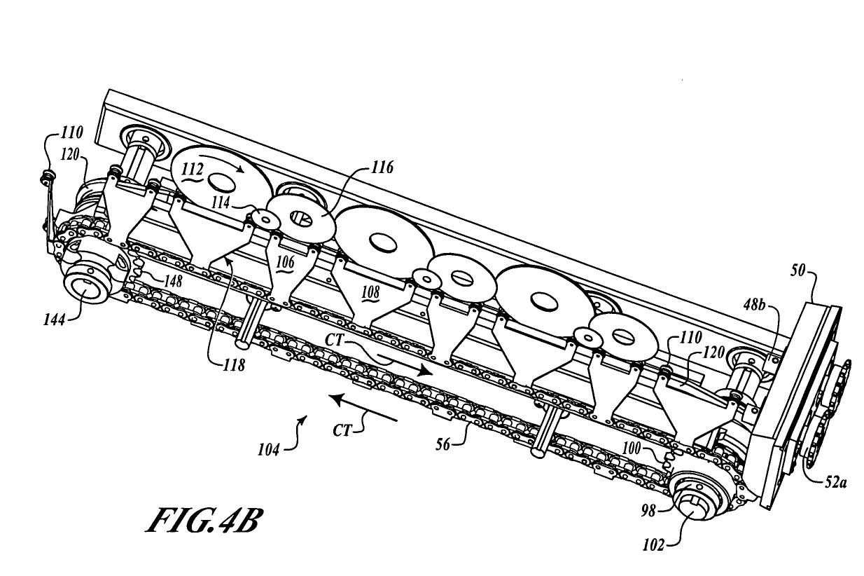

FIG. 3A shows a conventional LFF disk cascade scrubber assembly 38 with the hollow brush mandrels 40a, 40b inserted into the sockets 42a, 42b of the fluid (DI water with optional cleaning compound(s)) manifold block 44 via seal couplings 46a, 46b at the left end, and to the bayonet couplings 48a, 48b of the transmission 50 at the right end. The brushes are rotationally driven by sprockets attached to the drive shafts 52a, 52b. As the disks 96 travel along the line from left to right in FIG. 3, they spin (rotate) as shown by Arrow S in the direction opposite the direction of travel, Arrow L. The brushes rotate inward, Arrows R, they scrub clean the disks, pushing them downward into engagement with the disk rotation belt (see FIG. 4A), while the pusher assemblies 54 transport them along the lane. Each disk is captured fore and aft by a pair of pushers 54a, 54b which are secured to the transport drive chain 56. Adjustments to line transport speed and pusher location can be made using the disk transport adjustment assembly 58. The disks are placed into the nip between the brushes 60a, 60b at gap 62 and picked out at gap 64. Since the mandrels are hollow, water supplied through manifold block 44 flows out through the sponge-type brushes 60 during cleaning of the LFF disks.

In contrast, FIG. 3B shows the inventive SFF pallet assembly 36, comprising a base plate 66 on which are mounted an idler assembly 68 at the left end and a transmission assembly 70 at the right end. The inventive SFF pallet assembly is sized to fit into the footprint of the LFF cascade scrubber between the LFF mandrel water manifold block 44 and the LFF drive assembly 50. The much smaller brushes 160a, 160b on their mandrels 72a, 72b (typically solid) are journalled into SFF idler and transmission assemblies 68, 70 at their opposite ends. When the SFF pallet is in place (see FIGS. 1 and 2) the SFF transmission assembly 70 includes gearing that transfers rotary power from the LFF transmission 50 via the couplings 74a, 74b to the brushes. The idler assembly includes a clamshell-type bearing housing 76 holding the ends of the brush mandrels 72a, 72b in a static position, but permits them to freely rotate. The manifold couplings 78a, 78b are, in this embodiment, static bosses or disks 78a, 78b on which Q-rings are mounted to fit snugly into the sleeves or sockets 42a, 42b of the conventional scrubber housing when the SFF pallet assembly 36 is mounted in place in the scrubber bay 16 (see FIGS. 1 and 2). Since in this embodiment the SFF bosses 78a, 78b have no fluid conduits and there is a gap between the end of the mandrels 72a, 72b and the boss bracket 80, no water is supplied via the manifold block 44 (see FIG. 3A).

In an alternate embodiment of the inventive SFF pallet, the mandrels are hollow to provide inside-out flushing of the brushes. In this embodiment the mandrels extend into the bosses 78a, 78b and each of the bosses includes a passageway that leads through the idler assembly housing into the hollow mandrels so that they feed water from the manifold 44 into the SFF mandrel bores. As before, input gap 62 and output gap 64 are provide for the pick and place finger clearance. There also may be gaps 82 between adjacent scrubber zones.

FIG. 4A shows the LFF scrubber line with the brushes removed, revealing the transport assembly 84 for moving the disks down the scrubber line. A plurality of spaced, single pusher fingers 54 are attached to the chain 56 (direction of motion shown by the arrows), and extend across the chain guide 86 onto the roller guide 88. The pushers comprise a finger 90 having a single roller 92 at the end which pushes the LFF 95 mm disks 96 (four being shown) as they move along the grooved rotation belt 94. The motion can be from either end; as shown the input end is at the left and the clean, output end is at the right. The larger space between adjacent fingers is for a 95 mm disk; the smaller space is for a 65 mm disk, to accommodate two sizes of LFF disks which represent the standard in the industry at the time the cascade scrubbers became commercially available. A belt (not shown) drives the disk rotation belt 94 drive pulley 98. Both the pulley and the disk transport chain drive sprocket assembly 100 are mounted on common shafts 102, but the grooved belt 94 is driven the opposite direction of the chain drive 56, that is right to left in the figure so that the disk rotates around its center (clockwise in the figure) while the chain 56 drives the pusher finger assemblies 54 left to right to move the disks, while rotating clockwise, left to right. Note the four disks lie in a common plane, called the scrubbing plane which includes the nip between the brushes.

At the left end is the mandrel idler housing assembly 44, the sleeves or sockets 42 for the idler bearings of the mandrels being shown. At the right end, the mandrel drive transmission assem-bly 50 is shown. Sprockets 52 are chain driven in counter rotation, and the output shafts have pins to engage the bayonet sockets of the brush mandrels (see FIG. 3A).

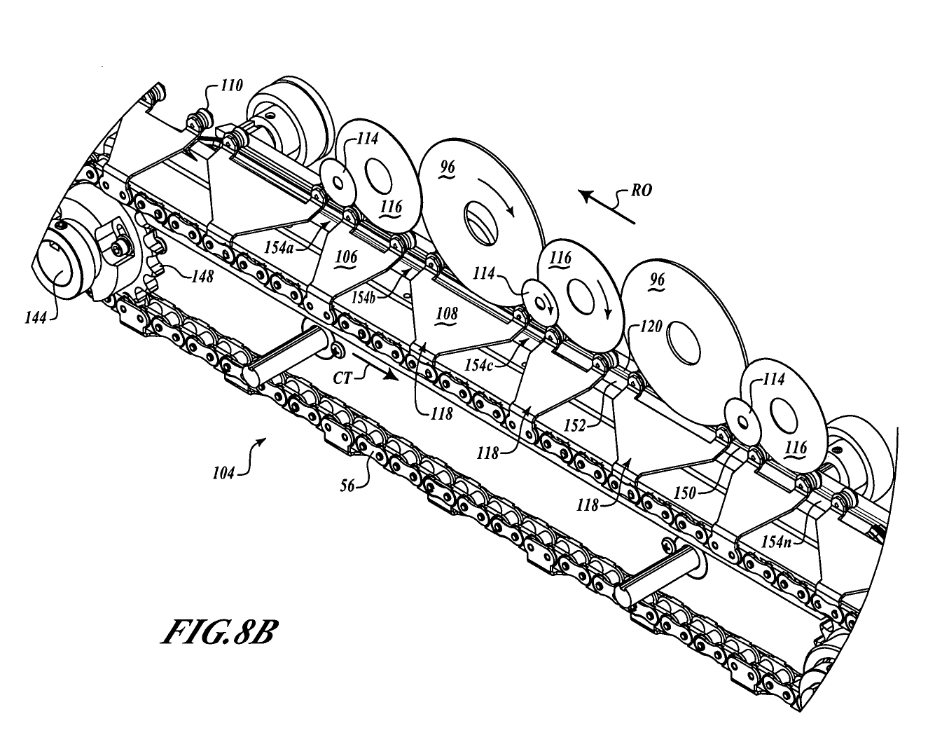

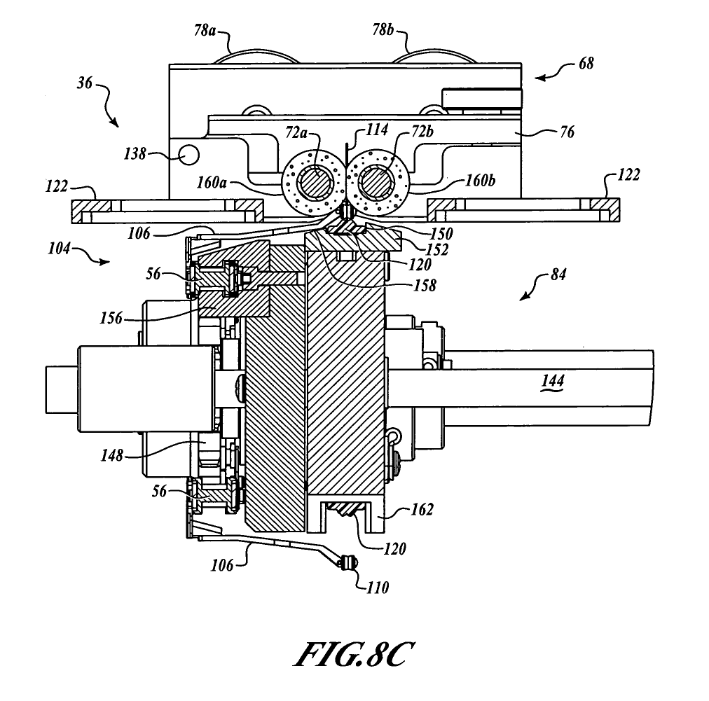

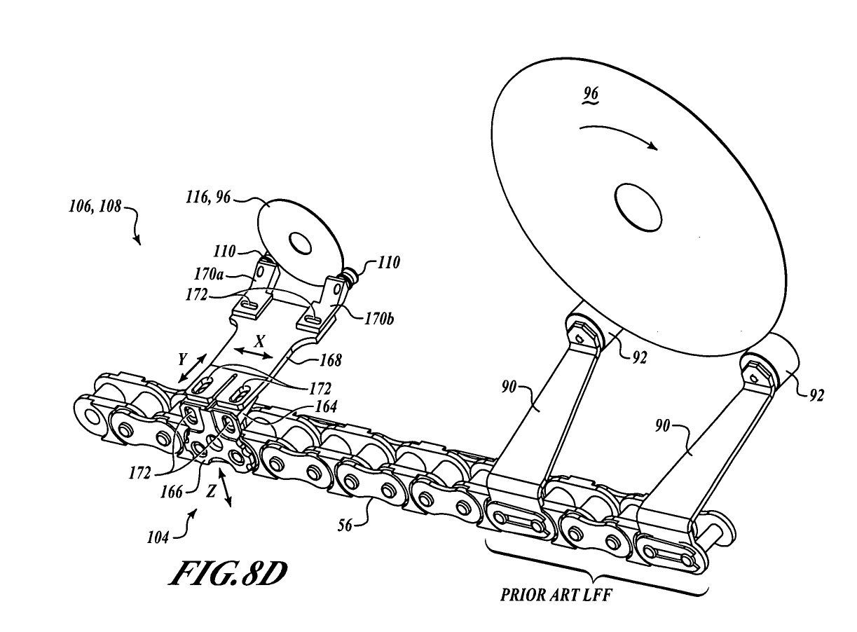

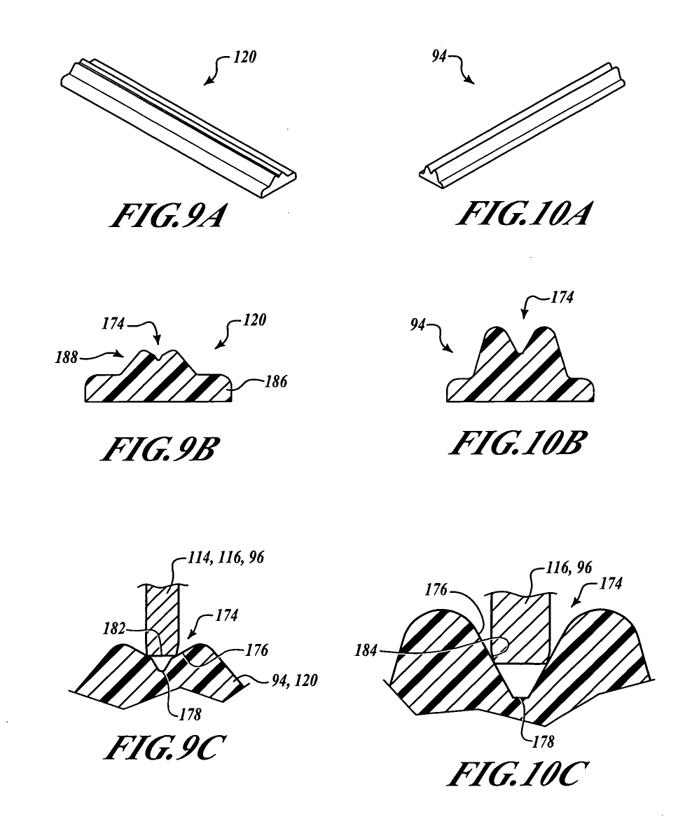

FIG. 4B shows the small form factor universal transport assembly 104 retrofitted onto a conventional large form factor disk cascade scrubber. Attached to the chain 56 at specified intervals are two sizes of new, SFF 2-digit, finger yokes 106 and 108, alternatingly fitted on the chain so there is a sequence of spacings between finger yoke rollers 110 for SFF disks, here given as examples are 48 mm, 21.6 mm and 28-35 mm disks 112, 114 and 116, respectively. Note the yokes 118 are all two-fingered, and the rollers 110 are grooved to receive the edge of the disks. The spacing between the centers of the rollers is less than the diameter of the disks that the rollers 110 push. Each yoke is linked to the chain 56, the direction of motion of which is shown by the arrows. The rollers 110 run along above the SFF rotation drive grooved belt 120, the direction of motion of which is right to left. As in the configuration of FIG. 4A the disks roll as they are moved longitudinally down the scrubber lane along the grooved belt 120 via motorized chain drive 100 and belt drive 98. The rollers need not be grooved, although the groove is presently preferred to provide better stability during rotation and transport of thin, small disks. The yokes may have fixed dimensions or may be fully adjustable, as shown and described in connection with FIG. 8D, below.

Thus, the universal disk transport assembly 104 comprises a chain 56 fitted with alternating yokes 106, 108 mounted thereon fitted in place of the original chain 84 (see FIG. 4A). By replacing the chain, the drive becomes universal, in that without further changing the chain or the spacing of the fingers 90 (see FIG. 4A) the chain plus alternating yoke system of the invention permits running different sized disks in the scrubber lane simply by dropping them in the appropriate spaces between the different fingers or between the alternating sized yokes. This is done simply by synchronizing the pick-and-place trolley assembly operation by command from the PLC controller of the scrubber module.

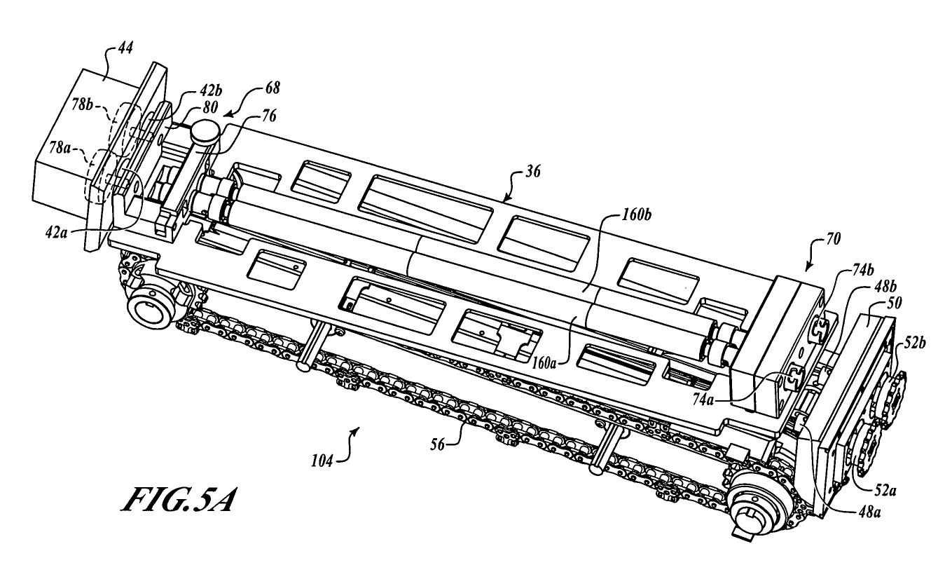

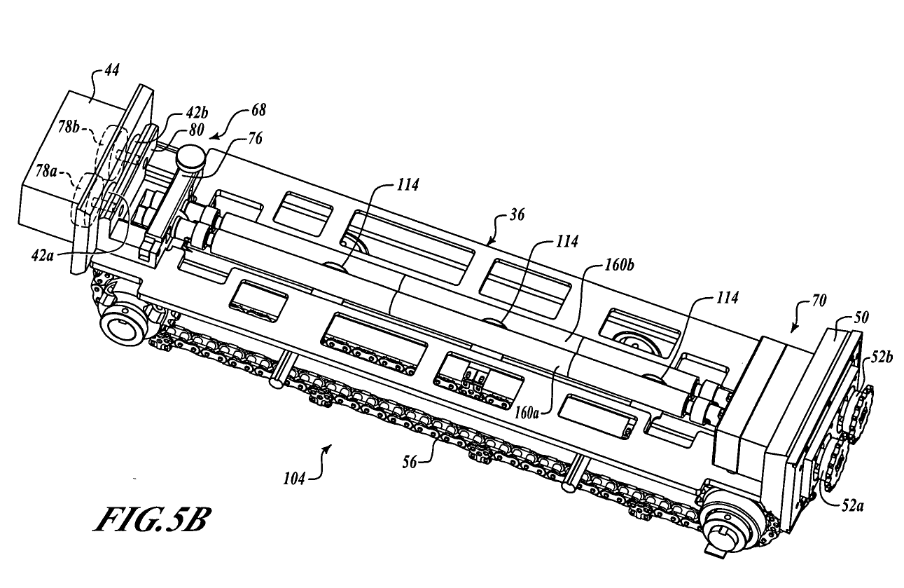

FIG. 5A shows the first step in fitting of the inventive SFF pallet into the footprint of a conventional LFF cascade scrubber 38 in place of the LFF brush mandrels 60a, 60b. Compare FIGS. 3A and 3B. That is, the LFF brush-carrying mandrels 60a, 60b of FIG. 3A are removed from their LFF scrubber lane 38, and the SFF pallet 36 of FIG. 3B carrying the smaller brush/mandrel assemblies 160a, 160b, is inserted in place of them. In FIG. 5A, the double bosses 78a, 78b at the idler end 68 of the SFF fit snugly into the sleeves 42a, 42b of the LFF water manifold block 44. The bosses 78a, 78b have arcuate surfaces so that the pallet 36 can be inserted at an angle, idler end first. FIG. 5b shows the completion of the retrofit insertion of the SFF pallet 36 into the LFF scrubber lane 38. Note the right hand drive end 70 of SFF pallet 36 has been dropped down so that the drive bayonet receivers 74a, 74b (shown in FIG. 5A) receive the drive pins of the output shafts 48a, 48b of the LFF mandrel rotary drive unit 50.

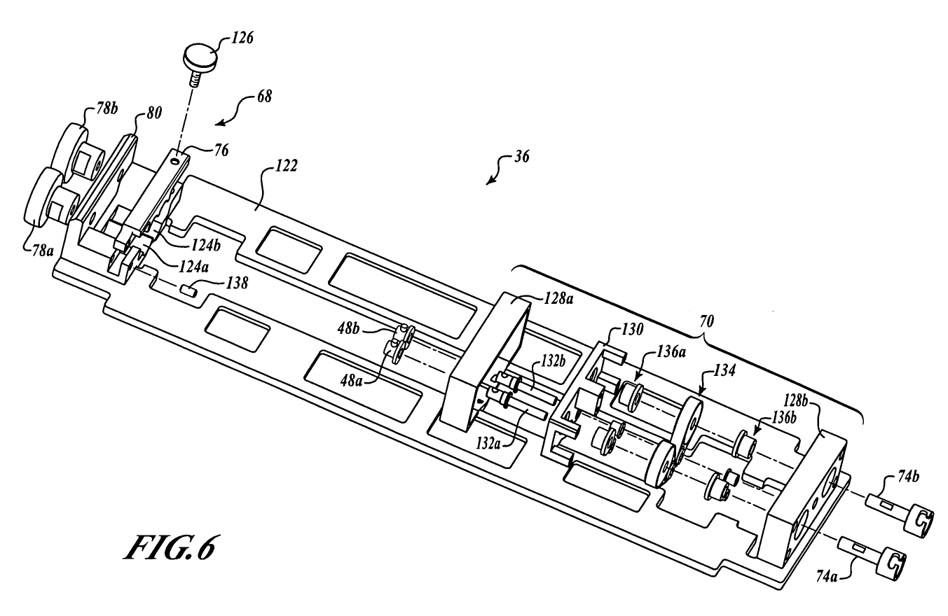

FIG. 6 is an exploded view of the parts of the pallet assembly of FIG. 3A with the numbering of parts being the same, and the mandrels and toothed pulley belts being removed to show the separation of the parts of the transmission. Starting at the left end of the base plate 122, the bosses 78a, 78b are mounted on shafts (not shown) retained by the boss bracket 80. The idler end of the mandrels are retained in bores 124a, 124b, the lower half in the boss bracket base and the upper half in the idler bearing housing capture plate 76, which is held down by thumb screw 126. Note the capture plate is pivoted at the near end. At the opposite, right end of the base plate 122 is the brush mandrel transmission drive assembly 70, which is connected at its input end to the bayonet couplings 74a, 74b (which connect to and receive rotational drive from the scrubber transmission 50, see FIG. 5A) and provides rotational motion to the scrubber brush mandrels (not shown) via the pin couplings 48a, 48b at its output end.

The SFF transmission 70 includes housing sections 128a, 128b and an internal gear mount framework 130. The output drive couplings 48a, 48b are mounted on output drive shafts 132a, 132b. The gear train 134 is retained in the framework 130 and aligned with the input shafts 74a, 74b and the output shafts 132a, 132b by means of suitable alignment/retainer coupling and spacer sets 136a, 136b.

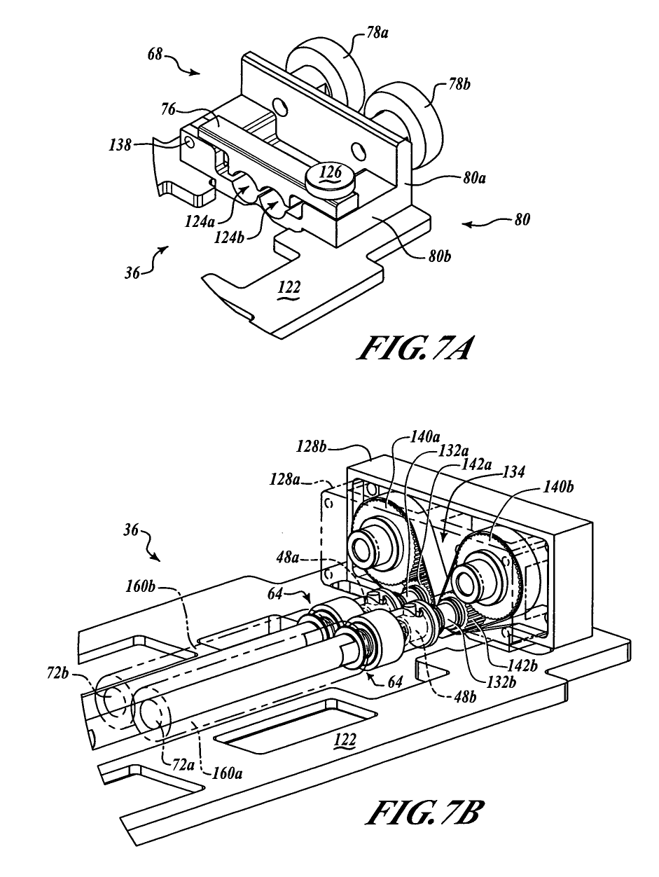

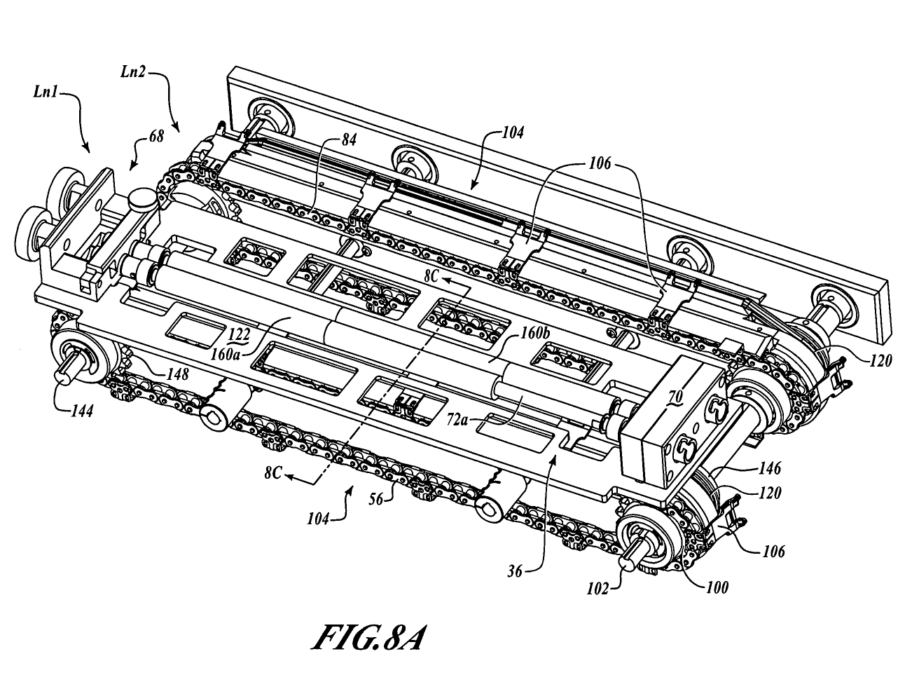

FIG. 7A shows the idler end of the SFF pallet assembly 36 having the idler bearing keeper 76 secured in place via thumbscrew 126; note it is pivotable from open to closed by pin 138. The bearing block 80 includes the boss bracket section 80a, and the baseplate 80b. Together, they capture the ends of the mandrels in the bores 124a, 124b. The bosses 78a, 78b that fit into the bores of the water manifold block 44 (see FIG. 5B), are shown mounted to the bracket section 80a.

FIG. 7B shows the drive transmission end of the inventive SFF pallet 36 mounted on base plate 122. The inner end of the housing 128a has been removed to show the transmission of FIG. 6 in an assembled configuration. The mandrels 72a, 72b, carrying brushes 160a, 160b are coupled to the transmission 70 via output male drive shafts 132a, 132b via mandrel female bayonet sleeves 48a, 48b. The gear train 134 comprises toothed pulleys and drive belts, the large gears 140a, 140b being driven by the input gear from the scrubber drive via the couplings 136b to the input drive shafts 74a, 74b (see FIG. 6) and the small gears 142a, 142b driving the output shafts 132a, 132b via couplings 136a. Note the offset, more closely spaced small gears 142a, 142b permit driving the smaller mandrels 60a, 60b of the SFF pallet assembly. The step-up drive resulting from the large gear as the input increases the rate of rotation of the smaller mandrels, and the input rpm (via sprockets 52a, 52b in FIG. 5B) can be adjusted to accommodate the surface area of the disks being scrubbed.

FIGS. 8A-8C are isometric views of the disk transport and disk rotation drive assembly 104 for longitudinal transport and rotation of disks in the inventive SFF pallet 36. FIG. 8A shows a dual lane cascade scrubber, with one of the inventive pallet assemblies 36 mounted in Lane 1, Ln-1, within the footprint of a standard LFF disk cascade scrubber, just spaced above the drive assembly 104 so that the horizontal plane defined by the centerlines of the two mandrel/brush assemblies 60a, 60b are at the diametric centerline of disks resting on the grooved rotation belt 120 that is driven by a pulley at the left end of the assembly (not shown) on drive shaft 144; that pulley is in the corresponding location as belt idler pulley 146, shown at the right end. The transport chain drive sprocket 100 is mounted on the jack shaft 106 while the idler sprocket 148 is on shaft 144. Thus, the chain and belt are separately driven, one clockwise and the other counterclockwise with respect to the figure.

FIG. 8B shows a close up of the transport yoke system and the grooved disk rotation drive belt 120 riding in belt guide slot 150 in top guide strip 152. In this embodiment yokes 106 and 108, respectively are alternately mounted on the chain 84 with spacing 154a, 154b, 154c . . . 154n between them for 1″ or smaller disks. It should be understood that this figure (and FIG. 4B) is schematic to show where the disks rest either between the finger of the yokes or between adjacent yokes. As shown the disks overlap, but it should be clear that is not the case in operation. In actual operation no disks are permitted to overlap; the location and spacing of the yokes on the drive chain is selected so that multiple sizes of disks can be run in a single zone without having to reset yokes, but a single lane processes a single size of disks during a run. Thus the 25 mm or smaller disks are placed in the gaps 154a, 154b, 154c, . . . 154n between adjacent yokes in one run, and either disks 116 are placed in the smaller yokes 106 in a different run, or large disks 96 are place in yokes 108 in still another run. The small disks 114 would be scrubbed with the SFF pallet in place, while the larger disks 96 would be scrubbed with the LFF mandrels/brushes (see FIG. 3A). Which sized brush/mandrel assembly is used for disks 116 depends on their size, it being important that the entire disk surface, from the center hole inner edge to the outer disk periphery be scrubbed. The lower located, smaller brushes of the SFF pallet assembly would not be suitable for scrubbing the large disks 96, as shown. The disks rests in the groove of the rotation belt 120 which is moving in direction of Arrow RO, while the chain 56 is counter-rotating in the direction of Arrow CT. The disks are moved to the right by the grooved rollers 110, while the disks are rotated clockwise by the belt 120. Thus, with one alternating mounting of the finger yokes with appropriate spacing, the inventive yokes can be mounted on the transport drive to handle three or more different sizes of disks, merely by swapping out LFF mandrel/brush assemblies for the inventive SFF pallet assembly with its small mandrel/brush pairs.

FIG. 8C is a section view of the SFF pallet 36 mounted over and engaging the universal disk transport and rotation drive assembly 104. The parts numbering is the same as above for the pallet parts. The longitudinal drive chain 56 rides in a guide block 156, while the yokes 106 (shown, 108 (not shown) are supported by the chain 56 and ride clear of (above) the angled upper surface 158 (glide surface) of the rotation belt top guide strip 152, so that the grooved rollers 110 contact the edges of the disks in their lower halves. It is important that the rollers 110 float above the rotation belt 120 on the order of a millimeter or more, depending on the diameter of the disk being transported down the scrubber line. In addition, the rollers are clear of (pass below) the brushes, so that the brushes and rollers do not interfere with each others motion. Lower belt guide block retains the belt in position below the drive assembly 84. Jack shaft 144 drives the chain drive gear 100. Various other mounting blocks for the drive assembly 84 are shown.

FIG. 8D shows on the left side the adjustability feature of the inventive yokes that when mounted on the standard chain 56 of the disk scrubber line transport drove assembly converts it into a universal drive permitting a single transport drive system to be used with both the LFF fluid mandrel/brush assemblies and the inventive SFF pallet system. The inventive yokes employ slots and screws to permit change of dimension in one or more of X, Y and Z axes. As shown: The X dimension is longitudinal, that is, parallel to the grooved disk rotation belt plane which is co-axial with the brush nip and together define the scrubber lane plane, e.g., Ln-1, Ln-2, . . . Ln-N; The Y dimension is lateral, that is horizontally orthogonal to the grooved disk rotation belt; The Z dimension is vertical, raising the rollers up or down with respect to the horizontal plane of travel of the grooved disk rotation belt and the horizontal centerline of the brushes. The inventive yoke comprises an inverted L-shaped bracket 164 (the “wrist” bracket) that is attached to a chain keeper plate 166 attached to the disk transport chain 56. A generally laterally extending extension plate 168 (the “hand” section) is attached to the upper portion of the bracket 164. This extension plate may have any suitable configuration, such as one or more medial bends for proper clearance, as best seen in FIG. 8C. The “hand” plate terminates in a pair of individual fingers 170. At each juncture, oval holes 170 permit the appropriate X, Y or Z adjustment. The securing screws are not shown for clarity due to the scale of the drawing.

Thus, the inventive universal disk transport system provides for essentially infinite adjustability for any sized disks. For example, keeping X and Y dimensions the same, raising Z means a smaller disk can be retained in the groove for transport stability, while reducing Z (lowering the rollers) means a larger disk can be retained. This adjustability feature also permits retaining the disks at user-selected distances down from the center hole of the disks. Smaller, thinner disks may need to be held higher along their edges than larger ones, or vice versa, as processing conditions may be varied and controlled, as non-limiting examples: rotation speed of brushes; indexing interval (dwell time in each zone and time of transit between zones); speed of the transport chain drive; rinse fluid composition and flow rate; disk rotation rate (grooved belt drive speed); and disk rotation direction (clockwise vs counterclockwise); to name a few. The height of the rollers above the belt can be varied from on the order of 0.25 mm to 25 mm, the range being to not contact the disk rotation belt 120 or the surface of the brushes.

Shown at the right in FIG. 8D are non-adjustable pusher fingers 90 of the prior conventional LFF system, also mounted on the chain 56. It is within the principles of this invention that these fingers can also be modified to have X, Y, Z axis (dimension) adjustability using the same multi-part, slots and screws assembly as with the yokes. Stated another way, the inventive adjustable yokes may be fitted with a single finger, or only one of the two fingers need be used for running with large format disks. That is, one of the fingers of each of appropriate adjacent yokes 106, 108 can be removed to provide the desired spacing.

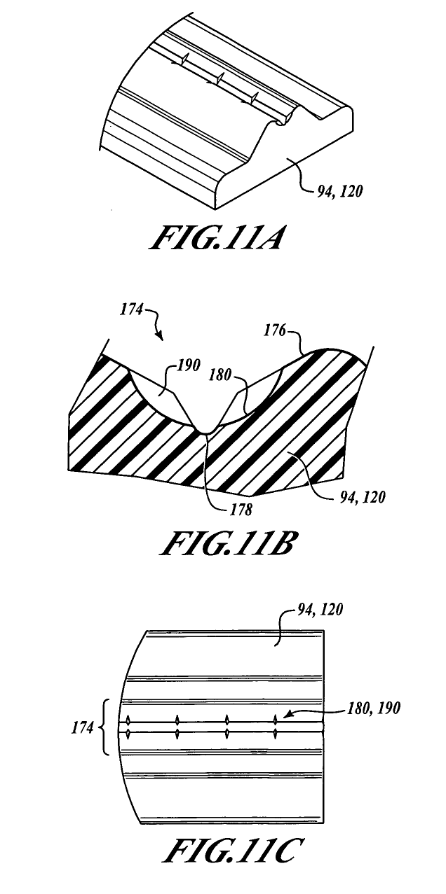

FIGS. 9A-C, 10A-C and 11A-C are line drawings of three embodiments of disk rotation belts 94, 120, in which FIGS. 9A-C show the details of the belt 120 for 48 mm disks and smaller, FIGS. 10A-C show the belt 94 for 65 mm and larger disks, and FIGS. 11A-C show the details of a belt having transverse grooves or treads 180 spaced along the longitudinal groove 174. In each of these series the FIGS. 9A, 10A and 11A drawings are isometrics of the belt; FIGS. 9B, 10B and 11B are full profiles (cross sections); FIGS. 9C and 10C are enlarged profiles; and FIG. 11C is a plan view of the belt of FIG. 11A showing cross-grooves or raised treads 180 for engaging the disk edges to assist in rotation. The belts comprise a planar base 186 on which a sloping raised mound 188 is located, in which the groove is formed. The groove typically has inwardly sloping shoulder segments 176 and terminated in a groove bottom 178. Note in both FIGS. 9C and 10C, the edge of the disk 114, 116, 96 does not touch the bottom of the groove. In FIG. 9C the disk edge face 182 contacts the shoulders 176. In FIG. 10C the edge chamfer of the disk 184 contacts the sloping shoulder 176. As seen in FIG. 11B a semicircular transverse V-shaped groove 180 is cut across the groove 174 to a depth approaching the bottom 178 of the groove 174. Alternatively, the shape of the groove may follow the profile 176, 180, so the segment between them forms a raised tread 190. The groove 180 is presently preferred. It is within the skill in the art, in view of the principles taught herein: that the groove is to uniformly and continuously center and rotate the disk during the scrubbing cycle, yet the disk should not become wedged into the groove so that it is difficult to move it longitudinally down the line or to pick the disk out of the groove at the end of the scrubber line, to design a wide variety of belt profiles to achieve those functions. A typical included angle for center groove 178 is from about 40 to about 65° and the outer groove 176 is from about 100 to about 140°. The belts may be made of any suitable, tough, relatively inelastic polymer, such as polyurethane, with a firm durometer, typically in the range of 80-90.

FIGS. 12-15 are a series of drawing of several embodiments of the robotic lateral transfer pick-and-place disk handler assembly 200 (Xfer/PNP) for a dual lane cascade scrubber employing the inventive SFF pallet.

As seen in FIG. 12 the Xfer/PNP assembly comprises a housing side-wall mounting plate 202, to which is mounted the lateral transfer drive assembly 210. In turn the drive assembly 210 carries the traveling vertical elevator assembly 220 at the top of which is mounted the PNP assembly 230. The mounting plate 202 carries brackets 204, guide 206 and drive belt pulleys 208. The lateral transfer motor 212 powers the drive belt 214, to which is secured the traveling carriage 216 and the elevator support bracket 218. The vertical elevator assembly 220 comprises brackets 222a, 222b to which is mounted motor and drive belt assembly 224 and the elevator plate 226. The vertical elevator assembly 220 is powered up and down in the direction of Arrow L on command of the PLC in proper timed sequence by motor 224. The entire elevator 220 is mounted on a lateral, horizontal transfer carriage assembly 216, the motion of which is in the direction of Arrow T as powered by motor 212 driving transfer belt 214 in response to timed signals of the PLC.

At the top of the elevator plate 226 of the PNP robotic handler assembly 230 is mounted a multi-part adjustable yoke assembly 232 (described in more detail below in reference to FIGS. 13A, 13B). from which are suspended pick arms 234a, 234b on the ends of which are mounted pick finger assemblies 236a, 236b. The yokes 232 and elevator plates 226 as mounted on the mounting brackets 222 and the traveling carriage 216 are together also called the trolley (22 in FIG. 1).

FIGS. 13A and 13B show two different embodiments of the PNP robotic handler assembly 230. The pick arm support yoke assembly comprises back plate 232a that is secured to the elevator plate 226 (FIG. 12) and arm yoke plate 232b that is adjustable in the longitudinal direction as shown by Arrow AD. The arm plate 232b is carried on rods 238a, 238b, and the distance from the back plate 232a is precisely adjusted by one or more set screws in adjustment block 240 bearing against stop block 242. The once set the yoke plate 232b is secured by screws in slots 244. This is an important skew alignment feature that insures the lateral travel T between the disk bays 14, 18 and the scrubber bay 16 is properly orthogonal (see FIGS. 1 and 2) and precisely aligned to pick up the disks 114 from the nests 20. The arms 234a, 234b are secured to the arms of the yoke 232b and stabilized by gussets 246 to reduce and dampen vibration, particularly harmonic vibration.

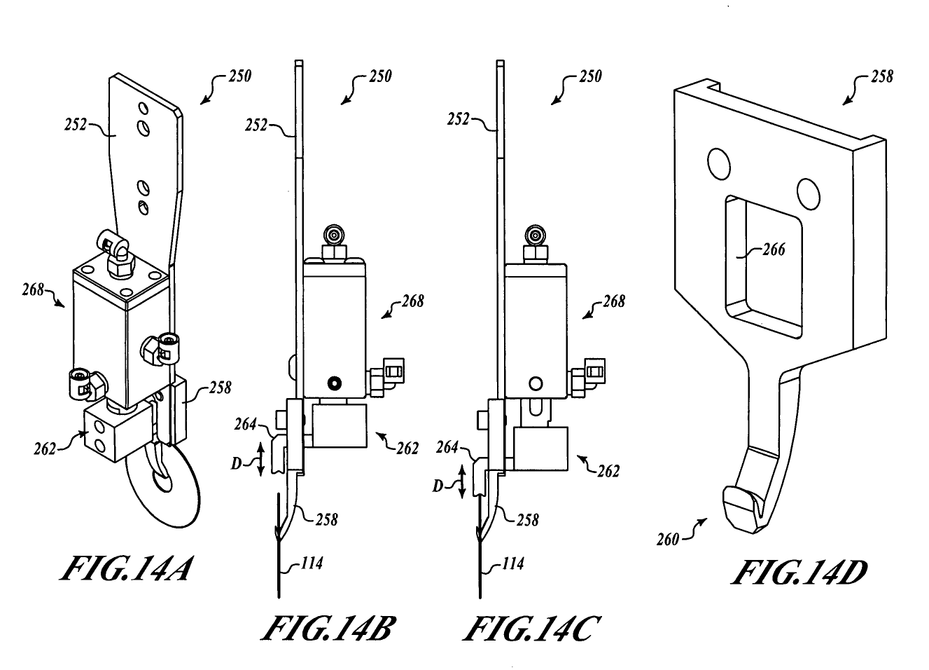

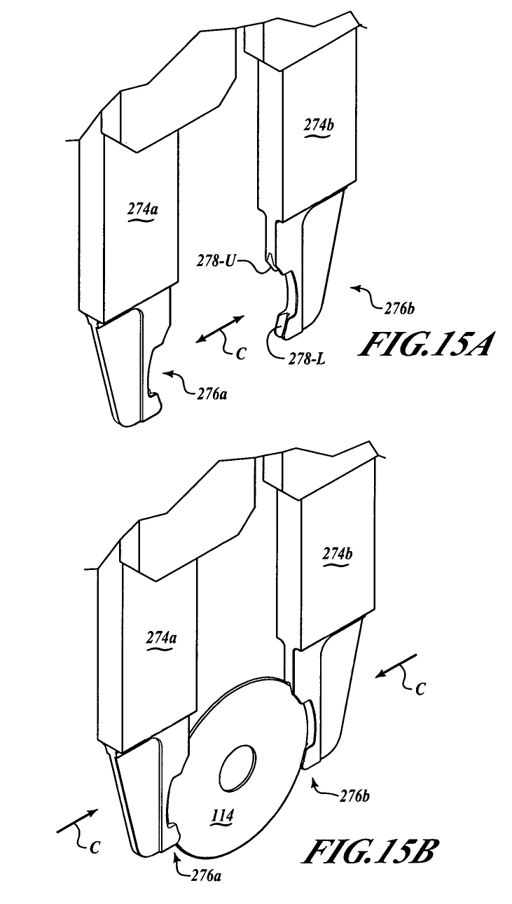

In FIG. 13A the pick arms 234a, 234b terminate in disk pick assemblies 250, a static hook-type center hole pick-up in FIG. 13A and FIGS. 14A-14D and a forceps-type disk edge pick-up in FIG. 13B and FIGS. 15A, 15B.

In FIG. 13A the finger 252 is mounted to the end of the arm 28, 234 via orthogonally orient-ed adjustable mounting blocks 254, 256 that permit precise alignment of the pick fingers with the disks as resting in the nests 20 and the scrubber nips. As best seen in FIGS. 14A-14D, secured to the tip of the finger 252 is a tip element 258 which terminates in a hook 260 that, during the PNP operation, is laterally inserted in the center hole of the disk 114, then raised to lift the disk from the incoming nest or out of the scrubber nip, and by the reverse motion inserted in the nip or placed on the outgoing nest. The screws holding the fingertip element are not shown. Mounted to one side of the finger 252 is an optional vertically reciprocable damper 262 that includes an L-shaped damper finger 264 that terminates in a groove to engage the top of the disk 114. The motion of the damper finger is shown by the Arrow D. Note the hole 266 in the finger tip 258 that permits the damper finger 264 to pass through to engage the disk. The damper 262 is actuated by pneumatic, biacting actuator 268, the A-B inlets of which are best seen in FIG. 14A.

In FIGS. 13B, 15A, 15B, the pick arms 234 terminate in forceps disk gripping assembly 270, which comprises powered fingers actuator 272 which pursuant to the PLC controller of the scrubber cause the fingers 274a and 274b to open and close as shown by Arrow C in FIG. 13B, 15A, 15B. The fingers 274a, 274b terminate in grooved tips 276a and 276b for grasping a disk, one disk being shown in position on the left in FIG. 13B and in FIG. 15B. The right actuator 272 in FIG. 13B is open, the left is closed. FIG. 15A is a close-up of the forceps tips 276a, 276b of the disk pick-and-place finger 274 with the fingertips open. FIG. 15B is a close-up of the forceps tips 276a and 276b of the disk pick-up fingers 274 with the fingers closed, holding a disk 114 in the upper and lower grooves, 278-U and 278-L, respectively.

As compared to the conventional LFF scrubber, the pick arms are more massive, have reinforcing ribs and have their strength dimension oriented transverse to the transfer motion of travel and are gusseted orthogonally to assist in reduction of harmonic vibration during transfer and up/down motion at the nests and nips. In addition, the damper of the FIG. 13A embodiment optionally assists to prevent loss of small disks during the PNP and transfer operations.

The robotic pick-and-place disk handler assembly 200 of FIGS. 1, 2, 12, 13A, 13B moves as follows, all in timed, preprogrammed signals from the PLC and configurable computer controller of the cascade scrubber in which the inventive pallet, drive and handler systems have been installed: Cassette(s) of 50 or more disks are unloaded (transferred) onto nests 20a raised by lifter 32 in the input bay or station of the scrubber module; single cassette if single lane, and two cassettes if configured for dual lane scrubbing. The lifter retracts to the position shown in FIGS. 1 and 2. The robotic handler transfers the yoke/arm trolley assembly to the correct position, the fingers or damper are opened (depending on the pick finger embodiment used), the arms descend via the elevator to the correct vertical position, the fingers close grasping a disk by the edges or the hook is indexed to center under the disk hole edge, the elevator raises the disk clear, the trolley lateral transfer belt is powered and the yoke moves into the scrubber zone where the pallet is located, the yoke/arms stop in the proper lateral position, the elevator lowers the arms inserting the disk in the nip between the scrubber brushes, the fingers open or the hook indexes to clear the hole, the disk is released in Zone 1 of the scrubber, the elevator raises the arm, and the yoke is translated back to the adjacent input cassette station to pick disk #2, and the process repeated. That process can Pick-N-Place 2 disks at a time.

An identical pick-and-place robotic handler is used at the output end, with the sequence in reverse from picking up a clean disk and returning it to an output, clean disk nest station. Note that in the case of dual lane scrubber, one lane can be configured to handle large disks and the other small. By retrofit of the inventive disk transport yoke and pallet systems described above in reference to FIGS. 8A-8D into a conventional scrubber module, it can handle multiple distinct sizes of disks.

### INDUSTRIAL APPLICABILITY

It is clear that the inventive multi-finger disk transport yokes and SFF small brush palette system of this application have wide applicability to the disk cleaning industry, namely to brush scrubber systems for the preparation of new, small semiconductor wafers and of disk substrates for HDDs, CDs, DVDs and the like. The inventive SFF palette, handler system and drive has the clear potential of becoming adopted as the new standard for methods of cleaning disk substrates smaller than about 50 mm in diameter.

It should be understood that various modifications within the scope of this invention can be made by one of ordinary skill in the art without departing from the spirit thereof and without undue experimentation. For example, the disk transport multi-finger yoke system can be re-sized to fit the disk diameter most in demand at any time in the industry, and differently sized diameter brush palettes can be manufactured to be retrofitted into the conventional standard mandrel manifold, as required. This invention is therefore to be defined by the scope of the appended claims as broadly as the prior art will permit, and in view of the specification if need be, including a full range of current and future equivalents thereof.

PARTS LIST To assist examination; may be canceled upon allowance at option of Examiner.

| | |
|---|---|
| 10 Cascade Scrubber Module | 70 SFF Transmission Assembly |
| 12 Housing | 72 SFF Solid Mandrels |
| 14 Disk Input Bay | 74 SFF Bayonet Couplings |
| 16 Scrubber Bay | 76 SFF Idler Bearing Housing |
| 18 Clean Disk Output Bay | 78 SFF Manifold Coupling Bosses |
| 20 a, b Input/Output Disk Nests | 80 Boss Bracket |
| 22 a, b Disk Transfer Assembly Trolley | 82 Zone Gaps |
| 24 Small Form Factor Disks | 84 Disk Transport Drive Assembly |
| 26 Pass Through Between Zones | 86 Chain Guide |
| 28 Pick Arm | 88 Roller Support/Guide |
| 30 Pick Finger | 90 Finger |
| 32 Elevator Mechanism | 92 Roller |
| 34 Drive Mechanism for DTA 22 a, b | 94 Grooved Rotation Belt |
| 36 Small Form Factor Pallet in Place | 96 Large Form Factor Disks |
| 38 Large Form Factor Scrubber | 98 Rotation Belt Drive Pulley |
| 40 Brush Mandrels | 100 Transfer Chain Drive Sprocket |
| 42 Sockets of Manifold | 102 Common Shaft |
| 44 Water Manifold Block | 104 Universal Disk Transport with Yokes |
| 46 Seal Couplings | 106 Small Finger Yoke for SFF (28-35 mm) |
| 48 Scrubber Couplings with Pins | 108 Larger Finger Yoke for SFF (48 mm) |
| 50 Transmission | 110 Finger Yoke Rollers (grooved) |
| 52 Mandrel Drive Shafts/Sprockets | 112 48 mm disks |
| 54 Pushers | 114 21.6 mm disks |
| 56 LFF Disk Transport Drive Chain | 116 28035 mm disks |
| 58 Disk Transport Adjustment Assembly | 118 Yokes |
| 60 Brushes | 120 SFF Rotation Belt |
| 62 Input Disk “Place” Gap | 122 SFF Base Plate |
| 64 Output Disk “Place” Gap | 124 SFF Mandrel Idler Bearing Bores |
| 66 Small Form Factor Pallet Baseplate | 126 Thumb Screw |
| 68 Small Form Factor Idler Assembly | 128 SFF Transmission Housing |
| 130 Internal Gear/Shaft Mount Frame | 190 Tread |
| 132 Output Shafts | 192 |
| 134 Gear Train | 194 |
| 136 Alignment/Retainer Coupling/Spacer | 196 |
| 138 Pivot Pin | 198 |
| 140 Large Gear | 200 Robotic Handler Lateral Transfer PNP |
| | Assembly |
| 142 Small Gears | 202 Sidewall Mounting Plate |
| 144 Drive Shaft | 204 Brackets |
| 146 Belt Idler Pulley | 206 Guides |
| 148 Idler Sprocket | 208 Pulley Assemblies |
| 150 Rotation Belt Guide Seat | 210 Lateral Transfer Drive Assembly |
| 152 Upper/Top Belt Guide Strip | 212 Motor |
| 154 Spacing Between Yokes | 214 Belt |
| 156 Chain Guide Block | 216 Traveling Carriage |
| 158 Slide Surface | 218 Elevator Support Bracket |
| 160 SFF Mandrels/Brushes | 220 Vertical Elevator Assembly |
| 162 Lower Belt Guide Block | 222 Mounting Bracket |
| 164 “Wrist” Bracket | 224 Motor Assembly |
| 166 Chain Keeper | 226 Elevator Plate |
| 168 “Hand” Section | 228 |
| 170 Individual Fingers | 230 Robotic PNP Assembly |
| 172 Oval Adjustment Holes | 232 Top Yoke (Trolley 22) |
| 174 Groove | 234 a, b Pick Arms (28) |
| 176 Shoulder of Groove | 236 a, b Pick Finger Assemblies |
| 178 Bottom of Groove | 238 a, b Rods |
| 180 Transverse Groove or Tread | 240 Adjustment Blade |
| 182 Edge Face of Disk | 242 Stop Block |
| 184 Edge Bevel of Disk | 244 Slots |
| 186 Base | 246 Gussets |
| 188 Mound | 250 Disk Pick Assemblies (30) |
| 252 Finger | |
| 254 Adjustable Mounting Block for Finger | |
| 256 Adjustable Mounting Block for Finger | |
| 258 Hook-Type Static Finger Tip Element | |
| 260 Hook | |
| 262 Damper | |
| 264 Grooved Damper Finger | |
| 266 Hole in Finger Tip | |
| 268 Actuator | |
| 270 Forceps-Type Disk Gripper | Arrow A From Upstream Module |
| 272 Actuator | Arrow B To Downstream Module |
| 274 Pick-Up Fingers | Arrow I Input from Cassette |
| 276 Grooved Tips | Arrow O Output to Cassette |
| 278 Grooves U, L | Arrow E Nest Elevation |
| 280 | Arrow AD Adjustment Directions |
| | Arrow L Lift |
| | T, Tᵢ to Transfer |
| | L Scrubber Line Direction of Travel |
| | Ln1, Ln2, Scrubber Lines 1 and 2 |
| | X Adjustment of Disk |
| | Y Adjustment of Disk |
| | Z Adjustment of Disk |
| | RO Rotation Belt Direction of Travel |
| | CT Chain Travel Direction |
| | C Open Close Pick Fingers |
| | D Damper Motion |

1. A pallet assembly for cleaning small form factor disk substrates in a cascade scrubber module having at least one scrubber lane, comprising in operative combination:
a) a generally rectangular base plate having a first and a second end and a slot generally parallel to the longitudinal axis of said plate;
b) a mandrel rotational drive assembly for counter-rotating a spaced pair of mandrels secured to said first end of said plate;
c) a mandrel idler assembly secured to said second end of said plate for receiving said mandrels in aligned relationship relative to said rotational drive assembly;
d) a spaced pair of mandrels rotatably received in and extending between said drive and said idler assemblies, said mandrels being adapted to receive scrub brushes which, as mounted on said mandrels, define a nip into which disk substrates are inserted for cleaning while moving down said scrubber lane;
e) said pallet drive assembly including a coupling for connection to a mandrel drive of said scrubber module to transfer rotational motion from said scrubber module drive through said pallet drive to said pallet mandrels;
f) said idler assembly including fittings for engaging the bores of a manifold block of said cascade scrubber; and
g) said pallet assembly is configured to permit substrate disks, upon insertion in said brush nip, to engage a disk rotation and transport assembly of said cascade scrubber through said slot in said pallet base plate for cleaning transport down said scrubber lane.

2. A pallet assembly as in claim 1 wherein said brushes include a gap adjacent a first end of said mandrels defining a disk placement space that permits introduction of a disk engaged on a finger assembly of a pick-and-place assembly into said mandrel nip without wear on said brushes, and a gap adjacent a second end of said mandrels defining a disk removal space that permits withdrawal of a disk from said mandrel nip by the finger assembly of a pick-and-place assembly without wear on said brushes.

3. A pallet assembly as in claim 2 wherein said mandrels are selected from dry mandrels and wet mandrels including central bore for introduction of rinse fluid from the interior of said mandrel radially out through a portion of said mandrel brushes.

4. A pallet assembly as in claim 3 wherein said mandrels are coupled to said mandrel rotational drive assembly by bayonet and pin fittings.

5. A pallet assembly as in claim 4 wherein said pallet mandrel rotational drive assembly is connected to said cascade scrubber mandrel drive by bayonet and pin fittings.

6. A pallet assembly as in claim 1 wherein said pallet mandrel idler assembly fittings are axially slidable in said cascade scrubber manifold block bores to provide clearance for said bayonet-and-pin fittings between said pallet mandrel drive assembly and said cascade scrubber mandrel drive to effect insertion and removal of said pallet from a lane in said cascade scrubber.

7. A pallet assembly as in claim 1 wherein said pallet mandrel drive assembly includes an offset drive train between the drive input from said cascade scrubber mandrel drive and the output to said pallet mandrels, said offset including a power transfer gear assembly.

8. A pallet assembly as in claim 1 wherein said mandrel idler assembly includes a pivoting housing member that is releasable to permit change-out of mandrels without disengaging said pallet assembly from said cascade scrubber lane in which it is mounted.

9. An improved disk and wafer substrate cascade scrubber module assembly having at least one scrubber lane comprising paired, counter-rotating large form factor scrub mandrels fitted with brushes, a mandrel drive assembly at a first end of said lane, a scrubbing fluid supply manifold block at a second end of said lane, each of which said drive and said manifold block engages fittings on the ends of said mandrels to provide counter-rotation and scrubbing fluid to said brushes, and a substrate rotation and transport assembly disposed below said mandrels to engage said substrates when placed in the nip defined between said paired brushes, comprising in operative combination:
a) a small form factor pallet assembly disposed in at least one of said scrubber lanes of said cascade scrubber module in place of said large form factor scrub mandrels, said pallet having:
i) a first drive coupling assembly at a first end for engaging said cascade scrubber large form factor mandrel drive;
ii) a second idler assembly coupling at a second end for engaging said manifold block;
iii) a pair of counter rotating small form factor mandrels having brushes mounted thereon rotationally mounted between said first and second pallet couplings in an orientation defining a nip for small form factor disk substrates; and
b) said pallet permitting small form factor disk substrates introduced in said nip to engage said scrubber substrate rotation and transport assembly when fitted in said scrubber lane with said first and second couplings engaging said cascade scrubber mandrel drive and said manifold block.

10. An improved cascade scrubber module as in claim 9 wherein said pallet includes:
a) a generally rectangular base plate having a first and a second end and a slot generally parallel to the longitudinal axis of said plate;
b) a mandrel rotational drive assembly for counter-rotating a spaced pair of mandrels secured to said first end of said plate;
c) a mandrel idler assembly secured to said second end of said plate for receiving said mandrels in aligned relationship relative to said rotational drive assembly;
d) said pallet drive coupling transfers rotational motion from said scrubber module drive through said pallet drive to said pallet mandrels;
f) said idler assembly including fittings for engaging bores of said manifold block of said cascade scrubber; and
g) said pallet assembly is configured to permit substrate disks, upon insertion in said brush nip, to engage a disk rotation and transport assembly of said cascade scrubber through said slot in said pallet base plate.

11. An improved cascade scrubber module as in claim 10 wherein
a) said scrubber rotation and transport assembly includes a grooved substrate rotation belt disposed in the plane defined by said pallet base plate slot and a chain drive for said substrate transport along said lane, and
b) said chain drive is fitted with at least one configuration of yokes having at least a pair of spaced fingers terminating in rotatable rollers for engaging substrates to effect their longitudinal transport along said scrubber lane in said plane from an input at a first end of said pallet mandrels to an output position at a second end of said pallet mandrels.

12. An improved cascade scrubber module as in claim 11, wherein said chain drive is made universal by fitting it with at least two different configurations of yokes in which the spacing of fingers is different, said different yokes being alternatingly secured along said chain to define at least three different gap dimensions for transporting substrates of different size along said lane.

13. An improved cascade scrubber module as in claim 12 wherein said yoke fingers are adjustable in X, Y and Z dimensions.

14. An improved cascade scrubber module as in claim 11 which includes a pick-and-place trolley assembly for lateral transfer of disks positioned on nests in an input bay to the nip of said mandrel brushes adjacent a first end of said mandrels, and conversely from the nip of said mandrel brushes adjacent a second end of said mandrels, said trolley assembly including arms and finger assemblies configured to reduce vibration transmission to disks carried by said fingers.

15. An improved cascade scrubber module as in claim 14 wherein said trolley finger assemblies are selected from hook type pick fingers that engage the center hole periphery of disk substrates, and fingers that engage the outer periphery of substrates.

16. An improved cascade scrubber module as in claim 15 wherein said vibration reduction is selected from at least one of:
a) orienting said pick-and-place arm and finger assembly planes orthogonal to the direction of lateral transfer motion of said trolley;
b) said pick-and-place arm assembly has at least one of a mass and a reinforcing rib construction that does not harmonically reinforce the module operation vibrations; and
c) said finger assembly includes a retractable disk periphery-engaging damper member.

17. A method of cleaning small form factor disk or wafer substrates in a cascade scrubber module having at least one scrubber lane, comprising the steps of:
a) removing large form factor scrubber mandrels having large brushes mounted thereon from at least one scrubber lane of said module;
b) mounting a substrate and disk transport drive chain onto the scrubber substrate transport drive, which drive chain includes fingers having rotatable rollers spaced along said chain at distances from each other that corresponds to dimensions for engaging the periphery of small form factor substrates or disks being scrubbed;
b) orienting and mounting a small form factor pallet assembly that includes paired, counter-rotatable mandrels onto which are mounted small form factor brushes to form therebetween a brush nip, said pallet assembly being mounted into engagement with the scrubber module mandrel drive at a first end of said pallet and into engagement with a manifold block at a second end of said pallet, said pallet being mounted aligned with said transport drive chain so that small form factor disks or wafers are transported down the scrubber lane in the nip of said small form factor mandrel brushes;
c) sequentially placing disks or wafers into the nip of said small form factor brushes adjacent a first end of said pallet;
d) transporting said disks or wafers along said lane in said nip to effect scrubbing; and
e) removing said disks or wafers from said brush nip adjacent a second end of said pallet.

18. A method as in claim 17 which includes the step of rotating said disk or substrate around their respective center axes while they are being scrubbed during transport down said scrubber lane in said brush nip.

19. A method as in claim 17 which includes the steps of:
a) providing batches of disks or wafers to be cleaned to an input zone;
b) picking and transferring individual disks or wafers sequentially from said input zone to said first end of said brushes nip in said scrubber lane;
c) picking and transferring individual disks or wafers after scrubbing from said second end of said brushes nip to an output zone until accumulated in a predetermined batch number of disks or wafers; and
d) removing the accumulated batches of disks or wafers from said output zone.

20. A method as in claim 17 wherein said step of mounting said drive chain includes the preliminary step of fitting said chain drive with at least two different configurations of yokes in which the spacing of fingers is different, said different yokes being alternatingly secured along said chain to define at least three different gap dimensions for transporting substrates of different size along said lane.
